(19) United States
(12) Patent Application Publication
(10) Pub. No.: US 2002/0040350 A1
(43) Pub. Date: Apr. 4, 2002

(54) e-commerce method for e-commerce system

(76) Inventor: Takashi Shinzaki, Kawasaki (JP)

Correspondence Address: STAAS & HALSEY LLP, 700 11TH STREET, NW, SUITE 500, WASHINGTON, DC, 20001, US

(21) Appl. No.: 09/819,712

(22) Filed: Mar. 29, 2001

(30) Foreign Application Priority Data
Sep. 29, 2000 (JP) 2000-299650

(51) Int. Cl. H04K 1/00

(52) U.S. Cl. 705/74

(57) ABSTRACT

When a customer purchase a commodity via an e-commerce system, the customer's terminal sends a seller's terminal an order for a commodity and designates a non-residential place other than a residential place of the customer as a delivery destination, the seller's terminal notifies the customer's terminal transaction identification (ID) information peculiar to the order and requests the payment agent's terminal for payment for the commodity, for which the customer's terminal made the order, using the transaction ID information, the seller's terminal makes arrangements to deliver the commodity to the non-residential place, and the commodity is transferred to an receiver for the commodity at the non-residential place. With this e-commerce method for an e-commerce system, it is possible to protect personal information (e.g. address, name, telephone number) of a consumer. It is further possible to protect privacy information, such as preference, thought, and belief of individual person.

### BACKGROUND OF THE INVENTION

1. Field of the Invention

The present invention relates to an e-commerce method for an e-commerce system.

2. Description of the Related Art

Nowadays, transactions by so-called mail-order and transactions (e-commerce, hereinafter also called online shopping) via a network (online), such as over the Internet, have been drastically widespread. There have been proposed numbers of techniques to protect personal information (e.g., credit card number) indispensable for settlement of a transaction regarding to a customer's purchasing of a commodity online.

Such technique is exemplified by “secure credit card service”, which is provided by CyberCash corporation over the Internet (WWW: World Wide Web), or a settlement method as disclosed in JP-T-HEI 11-514763, Published Japanese Translation of a PCT application.

The “secure credit card service” attempts to realize a secure settlement system over the Internet. Specifically, upon settlement for the payment of the purchase in a shop established on the WEB (shopping site) using a credit card, it is prohibited from leaking personal information (e.g., address, name, age, credit card number, expiration of credit card; hereinafter called settlement information) necessitated for settlement to an unnamed third person by ciphering settlement information using a ciphering technique, such as SSL (Secure Socket Layer).

Meanwhile, in the technique disclosed in JP-T-HEI 11-514763, procedures of settlement for an online transaction between a customer and a shop are carried out via a secure network separated from the Internet, where a plurality of unspecified people can access, so that it is prohibited from leaking personal settlement information to a third person, likewise the “secure credit card service”.

In another conventional method as disclosed in “Integrated interface for vendor/product oriented internet websites” (U.S. Pat. No. 5,895,454), since it is inconvenient for a customer to arrange payment for individual purchase of a commodity or for a purchase of a commodity in individual shopping site, an intermediate agent is disposed between the customer and a shop so as to manage the purchase by the customer in one or plural shopping sites in real time and grasp the total price of whole transactions. And upon settlement, the intermediate agent arranges payment for the whole purchase (order) in behalf of the customer by notifying the shop(s) of the customer's credit card number, which has been previously registered therein, via a network whose security is guaranteed or by other manner.

In the conventional e-commerce methods (also called B2C (Business To Customer)), considerable efforts are made to protect personal settlement information, such as a credit card number, throughout a network. But, there is little effort to prevent personal information (e.g., address, name, age) of a consumer (customer) from being notified a shop.

Namely, if a commodity sold/purchased via online shopping is a real physical matter, a shop demands personal information (e.g., address, name, telephone number, e-mail address) from a consumer because the commodity has to be surely delivered to the consumer via a transportation system or other means. In some case, a shop over-demands other personal information (e.g., place of work, occupation) of a consumer as necessitates information, which information has no connection with delivery of a commodity.

Therefore, the shop accumulates consumer's personal information, such as address, name, age, telephone number, and e-mail address (on some occasion, place of work or occupation), with ease. For example, the consumer may receive unnecessary direct mail or may be annoyed by other trouble caused from illegal use of personal information, or handover of personal information to a list agent.

Further, if personal information of a consumer is notified a shop in such e-commerce system, the shop can accumulate personal information associated with a commodity purchased by the consumer (customer) regardless the consumer's like or dislike to be accumulated consumer's personal information.

For example, a book is put on the online shopping as a commodity. The consumer, upon purchase of a book online, retrieves and purchases a preferred book without practically going to a bookstore and purchase plural books at a time without looking around in a bookstore, as advantageous points. However, on the other hand, since the shop can accumulate personal information of the consumer associated with information about the book purchased by the consumer with ease, it is possible for the shop to grasp consumer's preference, thought, and belief. Of course, the possibility should by no means limited to books, but other commodity (e.g., music CD (compact disc), an image medium (video tape, DVD, etc.) in which image is recoded) would have the same risk.

In the recent years, it is going to be common that a customer purchases a commodity as a Christmas present or the like in online shopping site and makes arrangements to deliver the present (commodity) to a friend or etc. In this case, it is possible for the shop to accumulate not only preference of the consumer but also information about companionship of the consumer with ease.

Therefore, in the conventional e-commerce method, since it is possible for a shop (seller) to accumulate not only consumer's personal information but also information about privacy (preference, thought, belief, and, on some occasion, companionship) of consumer with ease, the consumer would feel anxiety in making transaction online.

### SUMMARY OF THE INVENTION

With foregoing problems in view, it is an object of the present invention to provide an e-commerce method for an e-commerce system which can protect consumer's personal information (e.g., address, name, telephone number) and which can further protect information about consumer's privacy, such as preference, thought, belief, and companionship.

To attain the above object, according to a first generic feature of the present invention, there is provided an e-commerce method for an e-commerce system comprising the steps of: at the customer's terminal, sending an order to the seller's terminal for a commodity and designating a non-residential place other than a residential place of the customer as the delivery destination; and arranging the payment for the commodity, for which the customer's terminal made the order, using the transaction ID information (separated from the customer's personal information) via a payment agent's terminal. With this method, it is possible for the customer to perform the entire transaction, such as sending an order, making payment, and receiving a commodity, remaining anonymous to the seller. Partly since it is possible to prevent personal information and privacy information of the customer from being accumulated by the seller, partly since it is possible to relieve the customer due to a reduced possibility in leaking personal information and privacy information, it is possible to remove the customer's anxiety so that the e-commerce is enhanced.

As a preferable feature, at a commodity transfer place, certification is made as to whether the receiver for the commodity is an authorized receiver, using receiver certifying information which has been previously communicated between the seller and the customer. With this method, the secure and correct transferring of the commodity can be realized since it is possible to surely prevent the commodity from being transferred to an unauthorized receiver for the commodity.

As another preferable feature, the receiver certifying information, which is created at the seller's terminal, and price information of the transaction, together with the transaction ID information, may be notified to the customer's terminal; and the customer's terminal may notify the payment agent's terminal of the transaction ID information and the price information, which have been notified by the seller's terminal, via information communication network as the payment request. With this method, it is possible to make the fast and correct payment for the commodity keeping the personal information of the customer secret from the seller.

As still another preferable feature, the customer's terminal may notify the seller's terminal of receiver certifying information, which has been created by the customer's terminal when the customer's terminal has made the order, via information communication network. With this method, since the customer for the commodity can designate the receiver certifying information anything desired by the customer, it is possible to improve service to the customer.

According to a second generic feature of the present invention, there is provided an e-commerce method for an e-commerce system, wherein a payment agent's terminal purchases a commodity in behalf of a customer's terminal, comprising the steps of: at the purchase agent's terminal, sending an order to the seller's terminal for a commodity and designating a non-residential place other than a residential place of the customer as the delivery destination; and at a purchase agent's terminal, making the payment for the price of the commodity, for which the customer's terminal made the order, using the transaction ID information (separated from the customer's personal information) peculiar to the order. With this method, it is possible for the customer to perform the entire transaction same as the e-commerce method of the first generic feature keeping personal information of the customer secret from the seller. Especially, partly since the payment for the price of the commodity is arranged by the purchase agent's terminal in behalf of the customer, partly since the customer never directly communicates with the seller during the entire transaction, it is possible to further reduce the possibility in leaking personal information of the customer to the seller. As a result, it is possible to surely prevent the personal information of the customer from being accumulated by the seller.

According to a third generic feature of the present invention, there is provided an e-commerce method for an e-commerce system comprising a step of making arrangements, at a settlement agent's terminal, to pay to a purchase agent's terminal the price corresponding to the payment which the purchase agent's terminal has made in behalf of a customer. With this method, the customer can accomplish the e-commerce keeping the personal information of the customer secret from the seller without establishing an agreement with the payment agent to make arrangements to settle for the purchase of the commodity. Accordingly, it is possible for the e-commerce method of the third generic feature to attain the same advantageous result as that of the second generic feature and it is possible to improve service to the customer in e-commerce.

As another preferable feature, upon completion of delivery of the commodity to a designated delivery destination (non-residential place), the purchase agent's terminal or the seller's terminal may notify the customer's terminal of the completion of delivery of the commodity via the information communication network. With this method, since it is possible to prevent the customer from going to the non-residential place before the arrival of the commodity, service to the customer would be greatly improved.

With an additional preferable feature, the customer's terminal may be notified of the status of delivery of the commodity by making a notice on information bulletin board means set up in the information communication network and notified by the customer's terminal. With this method, partly since the customer can grasp the status of delivery of the commodity with ease, partly since it is possible to prevent the customer from going to the delivery destination (non-residential place) before the arrival of the commodity, service to the customer would be greatly improved.

According to a fourth generic feature of the present invention, there is provided an e-commerce method in an e-commerce system comprising the steps of, at a customer's terminal, requesting a payment agent's terminal to make arrangements to deliver a commodity to a delivery destination and designating a non-residential place other than a residential place of the customer as a delivery destination; at the payment agent's terminal, warranting the payment relating to purchase between a seller's terminal and the customer's terminal, which purchase is to be identified by transaction identification (ID) information peculiar to the delivery request, by an electronic document; and at the commodity delivery means, delivering the commodity to the delivery destination (non-residential place) designated by the customer. With this method, it is possible to accomplish the entire transaction keeping personal information of the customer secret from the seller, and it is also possible to avoid pecuniary trouble, such that the payment to the seller is not made despite of the commodity delivery. With this method, it is possible to realize secure and correct transfer of commodity and money even in an inter-person transaction exemplified by an auction site or a flea market.

As a preferable feature, upon transfer of the commodity, certification may be made as to whether the receiver for the commodity is an authorized receiver, using receiver certifying information, which has been previously communicated between the seller and the customer, at the delivery destination (non-residential place) designated by the customer. With this method, since it is possible to surely prevent the commodity from being transferred to a person other than an authorized receiver for the commodity, secure and correct transferring of the commodity can be realized.

As another preferable feature, the payment agent's terminal may make making arrangements to pay to the seller's terminal via the information communication network for the price relating to the purchase in behalf of the customer's terminal when the transferring of the commodity is confirmed by the payment agent's terminal. With this method, since it is possible to prevent the price relating to the purchase from being paid to the seller even when the commodity is not transferred to the customer, a fraud of the seller can be surely avoided.

According to a fifth generic feature, there is provided an e-commerce method for an e-commerce system with absence of one or more intermediate agent (e.g., the payment agent's terminal, the purchase agent's terminal, the settlement agent's terminal) comprising the steps of: at a customer's terminal, sending an order to a seller's terminal for purchase of a commodity and designating a non-residential place other than a residential place of the customer as a delivery destination at the customer's terminal; and at the delivery destination (non-residential place), arranging the payment using transaction identification (ID) information by the customer. With this method, the customer can accomplish the entire transaction, such as sending an order, making payment, and receiving a commodity, remaining anonymous to the seller. Therefore, it is possible to prevent personal information of the customer from being accumulated by the seller. Further, as a concise point, the customer 3 can accomplish the purchasing the commodity without establishing an agreement with an intermediate agent because of the absence of an intermediate agent.

As a preferable feature, upon transfer of the commodity, certification may be made as to whether the receiver for the commodity is an authorized receiver, using receiver certifying information which has been previously communicated between the seller and the customer, at the delivery destination (non-residential place) designated by the customer. With this method, since it is possible to surely prevent the commodity from being transferred to a person other than an authorized receiver for the commodity, secure and correct transferring of the commodity can be realized.

As another preferable feature, at the customer's terminal, the customer may make arrangements to pay a predetermined amount of money periodically to a customer's account established for the payment agent or the settlement agent to make payment in behalf of the customer; and at the payment agent's terminal, the payment agent may make a direct debit of a price regarding the purchasing of the commodity in the customer's account to make the payment. With this method, since the customer do not have to make payment each time when the customer purchase a commodity, it is possible to improve service to the customer in making transaction in an e-commerce system.

As a further preferable feature, upon commodity delivering, a sales slip medium containing the transaction ID information in the form of a read-out code representing the receiver certifying information may be delivered to the non-residential place and may be attached to the commodity; and upon commodity transferring, the receiver for the commodity may be certified as the authorized receiver, by reading out the transaction ID information of the sales slip medium using the receiver certifying information, which is known to the customer's terminal, as the read-out code. With this method, since it is possible to perform an exact certification as to whether the receiver for the commodity is an authorized receiver, the commodity would be surely transferred to the authorized receiver for the commodity.

As still another preferable feature, upon commodity delivering, the transaction ID information is ciphered with the read-out code as a code key; and upon commodity transferring, the ciphered transaction ID information of the sales slip medium is deciphered using the code key. With this method, since certification of a receiver for the commodity cannot carried out by simply reading the transaction ID information, it is possible to prevent the commodity from being transferred to a third person other than an authorized receiver for the commodity even if the third person falsely reads the ID transaction information from the slip medium.

As still further preferable feature, a digital signature of the authorized receiver for the commodity may be recorded in the sale slip medium using the receiver certifying information as a key for the digital signature of the sales slip medium. With this method, it can be recorded that the commodity is surely transferred to an authorized receiver for the commodity.

As still further preferable feature, the sales slip medium in which the digital signature is recorded may be delivered to the seller's terminal as a reusable receipt slip by the commodity delivery means. With this method, the seller of commodity can surely grasp the completion of transferring of commodity, and it is possible to make good use of resource for sales slip.

As still further preferable feature, upon commodity delivering, the commodity maybe delivered to a lockable commodity cabinet which is located in the non-residential place and is unlocked when the receiver certifying information, which is known to the customer's terminal, is input with respect to the commodity cabinet; and upon commodity transferring, the transferring of the commodity may be carried out as the commodity cabinet is unlocked by inputting the receiver certifying information, which is known to the customer's terminal, with respect to the commodity cabinet. With this method, since it is possible to surely transfer the commodity in secure even if there is no clerk at the commodity transfer place, the cost for hire can be reduced due to absence of a clerk, who performs certification of a receiver.

As still further preferable feature, the receiver certifying information may be biometrics data. With this method, since it is possible to perform extremely exact certification of the receiver for the commodity, secure and correct transferring of the commodity can be carried out.

As still further preferable feature, it may be notified to the seller's terminal or the payment agent's terminal via the information communication network that the transferring of the commodity has been carried out. With this method, the seller's terminal or the payment agent's terminal can grasp the completion of transferring of the commodity without time delay.

As still further preferable feature, information about the customer also may be sent from the customer's terminal to the seller's terminal via the information communication network as marketing information. With this method, the seller would make good use of the marketing information for commodity selling strategy to promote the sales of commodities.

As an additional preferable feature, when the customer cooperate the seller in marketing business (upon receipt of the marketing information from the customer's terminal), at the seller's terminal the seller may make a discount of the price of the commodity. With this method, both the customer 3 and the shop 2 can obtain benefit.

As still additional preferable feature, the marketing information may be age/sex information of the customer. With this method, since the customer cooperates the seller in marketing keeping personal information (e.g., address, name, telephone number) of the customer, which identifies the customer, secret from the seller, it is expected that the customer 3 becomes more willing to purchase a commodity and the e-commerce is drastically enhanced.

Other objects and further features of the present invention will be apparent from the following detailed description when read in connection with the accompanying drawings.

### BRIEF DESCRIPTION OF THE DRAWINGS

FIG. 1 is a diagram schematically showing an e-commerce method for an e-commerce system according to a first embodiment of the present invention;

FIG. 2 is a diagram showing an example of commodity-order data sent to a shop from a customer for the e-commerce system of FIG. 1;

FIG. 3 is a diagram showing an example of order-receipt notification data sent to the customer from the shop for the e-commerce system of FIG. 1;

FIG. 4 is a diagram showing an example of payment-request data sent to a payment agent from the customer in the e-commerce system of FIG. 1;

FIG. 5 is a diagram showing a manner of certifying a receiver for a commodity at a commodity transfer place for the e-commerce system of FIG. 1 ;

FIG. 6 is a diagram showing a manner of notifying a customer of a do-not-forget warning for the e-commerce system of FIG. 1;

FIG. 7 is a diagram showing a manner of sending a “receiver certifying information” to the shop from the customer for the e-commerce system of FIG. 1;

FIG. 8 is a diagram showing a manner of making a discount of the price regarding the purchasing of a commodity for the e-commerce system of FIG.

FIGS. 9 through 12 are flow diagrams respectively showing manners of making an agreement between the customer and the payment agent for the e-commerce system of FIG. 1;

FIG. 13 is a diagram schematically showing an e-commerce method for an e-commerce system according to a second embodiment of the present invention;

FIG. 14 is a diagram showing an example of purchase-request data sent to a purchase agent from a customer in the e-commerce system of FIG. 13;

FIG. 15 is a diagram showing an example of order-receipt data sent to the purchase agent from a shop for the e-commerce system of FIG. 13;

FIG. 16 is a diagram showing an example of order-receipt notification data sent to the purchase agent from the shop in the e-commerce system of FIG. 13;

FIG. 17 is a diagram showing an e-commerce method for an e-commerce system according to a third embodiment of the present invention;

FIG.18 is a diagram showing an e-commerce method for an e-commerce system according to a fourth embodiment of the present invention;

FIG. 19 is a diagram showing an e-commerce method for an e-commerce system according to a fifth embodiment of the present invention;

FIG. 20 is a diagram showing an example of commodity-order data sent to a shop from a customer in the e-commerce system of FIG. 19;

FIG. 21 is a diagram showing an example of order-receipt notification data sent to the customer from the shop in the e-commerce system of FIG. 19;

FIGS. 22 through 24 are diagrams respectively showing manners of transportation/transfer of a commodity according to the first through the fifth embodiments;

FIGS. 25 and 26 are diagrams respectively showing manners of making a digital signature on an IC card in the transportation/transfer manner of FIG. 24;

FIG. 27 is a flow diagram showing a manner of returning an IC card with a digital signature to a shop in the transportation/transfer manner of FIG. 24;

FIG. 28 is a diagram showing a manner of transportation/transfer according to the first through the fifth embodiment;

FIG. 29 is a flow diagram showing a manner of commodity transfer in the manner of FIG. 28;

FIGS. 30 and 31 are diagrams respectively showing manners of transportation/transfer according to the first through the fifth embodiment; and

FIG. 32 is a flow diagram showing a manner of commodity transfer in the transportation/transfer manner of FIG. 31.

### DESCRIPTION OF THE PREFERRED EMBODIMENTS

Various preferred embodiments of the present invention will now be described with reference to the accompanying drawings.

(A) First Embodiment

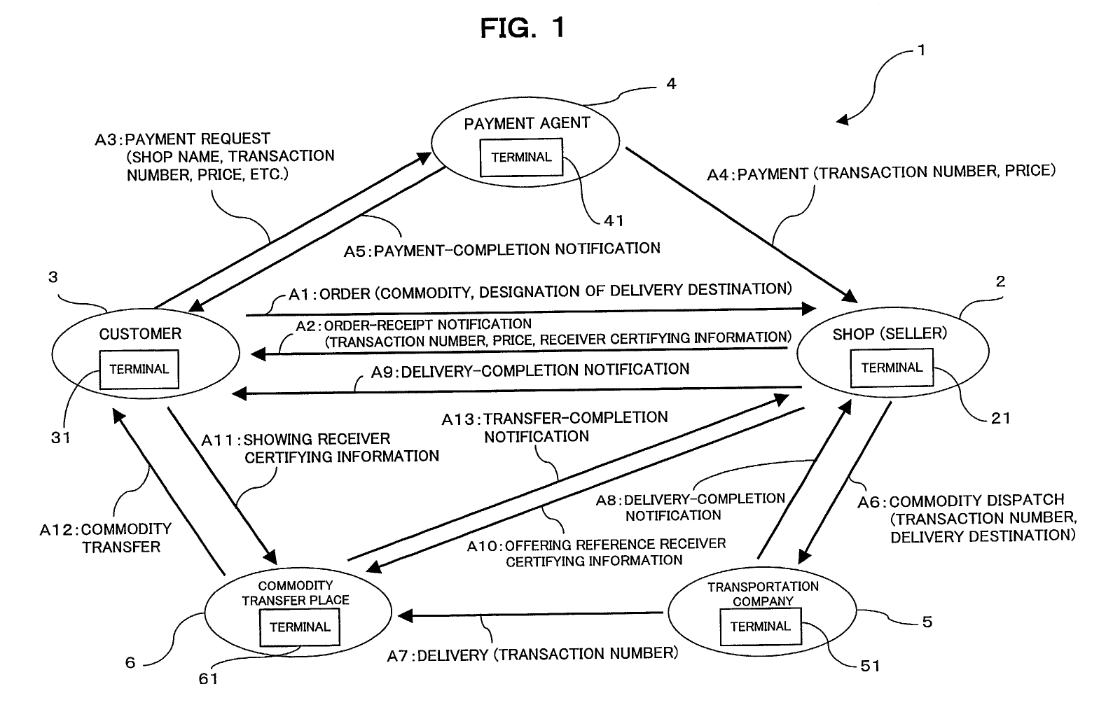

FIG. 1 is a diagram schematically showing an e-commerce method for an e-commerce system according to a first embodiment. The e-commerce system 1 of FIG. 1 comprises a shop (seller) 2 that sells commodities, a home of a consumer 3 (hereinafter also called a customer 3) that purchases a commodity, a payment agent 4, a transportation company 5 (e.g., a delivery company)containing a transportation system (commodity delivery means) for delivering a commodity to a designated delivery destination, and a commodity transfer place (commodity depository) 6.

The shop 2, the home of the consumer 3, the payment agent 4, the transportation company 5, and the commodity transfer place 6 are respectively equipped with information terminals 21, 31, 41, 51, 61 as a seller's terminal, a customer's terminal, a payment agent's terminal, a transportation company's terminal, and a commodity transfer place's terminal. Each of these various information terminals has a function of communicating information and is accessible to a desired information communication network (hereinafter also called network), such as the Internet.

Each of various information terminals 21, 31, 41, 51, 61 is installed WEB browser software for browsing, for example, contents (WEB site, e.g., a homepage) established on the Internet (WWW) and e-mail software for allowing to sent/receive e-mail, as the above-mentioned function of communicating information. As a result, when a demand arises, each of various information terminals 21, 31, 41, 51, 61 enables its user to browse a WEB site (contents) and to send/receive e-mail among other information terminals, via the Internet.

The behavior of each of various information terminals 21, 31, 41, 51, 61 for the e-commerce system I in the illustrated embodiment will now be described. The seller's terminal 21 of the shop 2 establishes a shopping site on the Internet by sending a shopping site (i.e., a homepage) to a non-illustrated WWW server. The seller's terminal 21 also receives an order for a commodity from a customer having accessed to the shopping site and makes an arrangement to deliver the ordered commodity to the transportation company 5.

The customer's terminal 31 of the home of the customer 3 sends an order for a commodity sold on the shopping site and requests the payment agent 4 for payment for the transaction of purchasing the commodity caused by sending the order. The payment agent's terminal 41 makes an arrangement to pay the shop 2 for the ordered commodity responsive to the payment request for the commodity issued from the customer's terminal 31.

The transportation company's terminal 51 receives the delivery request from the shop's terminal 21 and notifies the shop's terminal 21 of completion of the delivery of the commodity in accordance with the delivery request, via transportation system. The commodity transfer place's terminal 61 certifies as to whether the receiver for the commodity is an authorized receiver with respect to the commodity delivered via the transportation system and notifies the shop 2 of completion of transfer of the commodity.

The “commodity” sold/purchased in the e-commerce system 1 in the illustrated embodiment has to be a real physical matter (e.g., a book, a music/visual medium (a CD, avideo tape, a DVD, etc.), food, a ticket), which necessitates to be delivered by the transportation system. The “payment for the commodity (transaction)” may be a price of a commodity itself, or may be transportation fees and commission in addition to a price of a commodity. Meanings of these two wording are common to all embodiments in the present invention.

Using the above-mentioned e-commerce system 1 of illustrated embodiment, the customer 3 accomplishes the entire transaction, such as sending an order, making payment, and receiving a commodity, remaining anonymous to the shop 2. Being “anonymous” represents that not only the name of the customer 3 but also personal information (e.g., address or telephone number), which identifies the customer 3, is not known to the shop 2.

The e-commerce method for the e-commerce system 1 will now be described. First of all, the customer 3 makes an access to the shopping site provided by the shop 2 on the Internet via customer's terminal 31. Subsequently, the customer 3 selects for a purchase commodity, whereupon the customer 3 sends an order for the selected commodity to the shop 2 by sending an e-mail for the order, or filling out an order form previously prepared by the shop 2 and sending the form back to the shop 2.

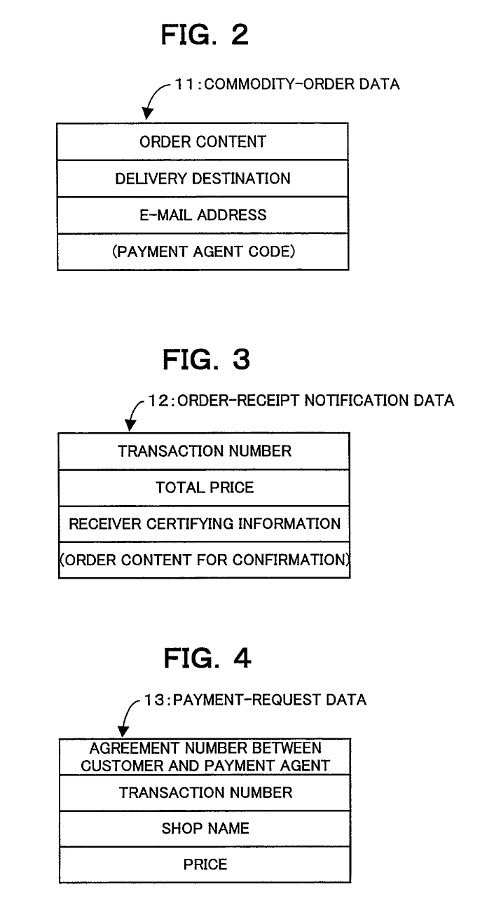

At that time, for example, the customer 3 sends only minimum (commodity-order) data 11 of “order content” (commodity name, quantity, etc.), “delivery destination for (delivering) the commodity”, and “e-mail address”, as shown in FIG. 2. The customer 3 designates a non-residential place other than a residential place of the customer 3 as the “delivery destination for commodity” so that the residential place of the customer 3 keeps secret. The customer 3 designates a neighboring convenience store, a branch office (a distribution center) of the transportation company 5, a post-office box, and etc. as the delivery destination. Namely, the customer 3 sending an order for a commodity to the shop 2 using an anonymous e-mail, an anonymous e-mail address, or the like (Step Al; order sending step).

The commodity-order data 11 may include information about designating the payment agent 4 (payment agent code) if there are a plurality of payment agents. In the illustrated embodiment, the commodity-order data 11 includes “e-mail address”. However, because it is difficult to identify the individual person based on only the e-mail address itself unless the e-mail address is associated with database having personal information, the shop 2 cannot accumulate personal information associating with an e-mail address when the e-mail address is sent with “order content” and “delivery destination”, which do not identify the individual person.

Upon receipt of the order, the seller's terminal 21 automatically creates “transaction number” and “receiver (customer) certifying information” for being used upon transfer of the commodity. These “transaction number” and “receiver certifying information”, together with “total price” of the transaction, are notified to the customer 3 in the form of order-receipt notification data 12 (FIG. 3) via the network (Step A2; transaction identification (ID) information notifying step).

The order-receipt notification data 12 may include information for confirming the order content, as shown in FIG. 3. Further, the order-receipt notification data 12 may be send to the customer 3 by e-mail or may be noticed on a bulletin board noticeable only by the customer 3 on the WEB site as a order-receipt notification screen.

Since the “transaction number” is information for discriminating the transaction identified by the commodity-order data 11, the “transaction number” should by no means limited to number information but may be in the form of proper character information, such as a pass-word or a pass-phrase. Such “transaction number” is applied to also the forthcoming embodiments.

Meanwhile, the “receiver certifying information” is confidential information for certifying, at commodity transfer place 6, as to whether the receiver for the commodity is an authorized receiver, and may be in the form of a proper pass-word and a pass-proper phrase as long as the individual person is not identified thereby. Namely, the “receiver certifying information” has nothing to do with personal information of the customer 3. Alternatively, the “receiver certifying information” is sent to the customer 3 in the form of an electronic certificate, whereupon the customer prints the electronic certificate out and shows the printed certificate at the commodity transfer place 6 so as to receive the commodity.

In the illustrated embodiment, certification is made at the commodity transfer place 6 as to whether the customer is an authorized receiver for the commodity by customer's possession of the confidential information of the “receiver certifying information” or a particular object, such as an electronic certification. This certification manner is applied to also the forthcoming embodiments.

Upon receipt of the order-receipt notification data 12, the customer 3 (the customer's terminal 31) requests payment for the transaction, which is caused by the commodity order, by notifying the payment agent 4 (the payment agent's terminal 41) of a payment-request data 13 containing an agreement number between the customer 3 and the payment agent 4 (hereinafter also called an agreement code), the “transaction number” notified by the shop 2, the name of the shop 2 from which the customer have purchased commodity and the total price to be paid to the shop 2, as shown in FIG. 4 (Step A3; payment request step).

At that time, the customer 3 does not have to notify the payment agent 4 of information about the purchased commodity (e.g., a commodity name). As a result, the customer 3 can also conceal customer's (receiver's) preference, thought, and belief from the payment agent 4.

Subsequently, upon receipt of the payment request data 13, the payment agent 4 (the payment agent's terminal 41) makes payment for the price regarding transaction to the shop 2 by remitting to a banking agency contracted with the shop 2 from an customer's (3) account established by a previous agreement, or by paying by a draft, or other means(Step A4). At that time, the payment agent 4 has to arrange the payment using the “transaction number” so that the shop 2 discriminates the payment corresponding to which transaction. Further, the payment agent 4 notifies the customer 3 of the accomplishment of making the payment by sending a payment-completion notification (Step A5).

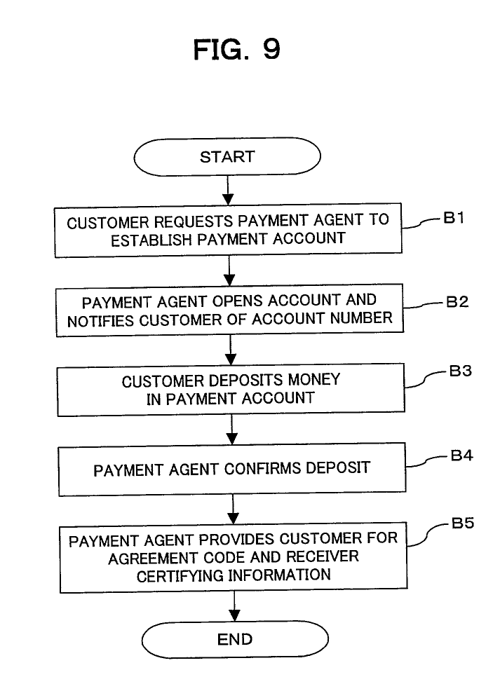

Manners of making an agreement between the customer 3 and the payment agent 4 will be described later with reference to FIGS. 9 through 12.

The shop 2 requests the transportation company 5 to make arrangements to deliver the ordered commodity (Step A6), whereupon the commodity is delivered to the delivery destination (the commodity transfer place) 6 designated by the customer 3 (Step A7; commodity delivery step), via the transportation system. The delivery request (arrangements) from the shop 2 to the transportation company 5 may be arranged by e-mail using the shop's terminal 21, the telephones, or human communication over the counter.

The transportation company 5 administers the delivery of the commodity using the “transaction number” by displaying the “transaction number” on the commodity package without using an ordinary destination (e.g., address, name, telephone number) and so on. This manner of administering is also applied to the forthcoming embodiments unless an alternative is suggested.

Upon completion of the delivery, the transportation 5 notifies the shop 2 of the completion of the delivery (Step A8), and then the shop 2 sends the customer 3 a “delivery-completion notification” by an e-mail or the like (Step A9). Since the “delivery-completion notification” prevents the customer 3 from going to the commodity transfer place 6 before the arrival of the commodity, it is possible to greatly improve service to the customer 3.

Alternatively, information about delivery status in accordance with each “transaction number” may be displayed on a bulletin board (information bulletin means) in the shopping site as the “delivery-completion notification” so that the customer 3 occasionally accesses to the bulletin board to make a notice on the delivery status of the customer's purchased commodity. Partly since the customer 3 can grasp the delivery status of the commodity, partly since the customer 3 also avoid going to the commodity transfer place 6 before the arrival of the commodity, it is possible to greatly improve service to the customer 3.

Upon receipt of the “delivery-completion notification”, the customer 3 goes to the commodity transfer place 6 to receive the commodity. At that time, certification is made as to whether the receiver for the commodity is an authorized receiver by use of the “transaction number” and “receiver certifying information” (commodity transfer step). The customer 3 shows the “receiver certifying information”, which have been previously notified by the shop 2, at the commodity transfer place 6 (Step All), whereupon the “receiver certifying information” is compared to a reference receiver certifying information provided by the shop 2 (Step A10). When the both certification information are identical, it is judged the customer 3 to be an authorized receiver for the commodity. Therefore the commodity is transferred to the customer 3 (Step A12), and a “transfer-completion notification”, which notifies a normal completion of transferring the commodity, is send to the shop 2 (Step A13).

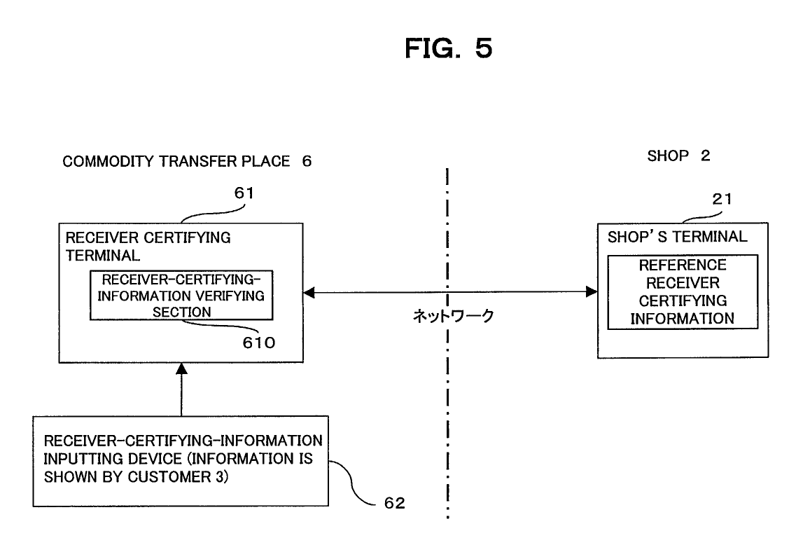

An example of a detailed manner of certifying of the receiver for the commodity is carried out as follows. The “receiver certifying information” shown by the customer 3 is input from the receiver-certifying-information inputting device (e.g., a keyboard of the terminal) 62 of the commodity transfer place's terminal 61, which has a receiver-certifying-information verifying section 610 and also has a function as a receiver certifying terminal as shown in FIG. 5. Concurrently, the commodity transfer place's terminal 61 receives the reference “receiver certifying information” retained in the shop's terminal 21 of the shop 2 for verification. The receiver-certifying information verifying section 610 compares the two certification information, and the result of comparison (match/mismatch) is displayed on a display section or other device of the terminal.

When the both certification information are identical, the “transfer-completion notification” is sent to the shop's terminal 21 of the shop 2 by e-mail or the like via the network. As a result, it is possible for the shop 2 to grasp the status of transferring commodities without time delay. The “transfer-completion notification” in the form of an e-mail may be ciphered so as not to leak to a third person and so as to improve security. Alternatively, the “transfer-completion notification” may be sent to the shop 2 by the mails, the telephones, or etc., which are other than e-mail.

In the e-commerce method for the e-commerce 1 of the illustrated embodiment, partly since the customer 2 sends an order for a commodity designating the commodity transfer place 6 of a non-residential place as the delivery destination of the commodity, partly since the payment agent 4 arranges payment for the transaction in behalf of the customer using the “transaction number” free from (irrespective of) the personal information of the customer 3, the customer 3 can carry out the entire transaction of sending an order, making payment, and receiving a commodity, without notifying the shop 2 of personal information of the customer 3 (address, name, telephone number, credit card number, etc.). Namely, the customer 3 can accomplish the entire transaction remaining anonymous to the shop 2.

Such e-commerce method can prevent the shop 2 from accumulating personal information of the customer 2. As a result, since it is possible to remove the customer's anxiety by a reduced possibility in leaking personal information, an increased opportunity of e-commerce can be provided to customers. Further, it is possible to drastically improve the security in settlement compared to the case of communicating the credit card number via the network for arranging payment (settlement). Still further, since personal information can be concealed, it is possible to protect not only business information of settlement but also customer's privacy, such as preference, thought, and belief, should be primarily protected.

In the illustrated embodiment, since the payment agent 4 is disposed between the customer 3 and the shop 2, partly since the payment agent 4 guarantees capability for payment of the anonymous customer 3 against the shop 2 so that the customer 3 sends an order for a commodity remaining anonymous to the shop 2, it is possible to guarantee security and to protect personal information and privacy on the same plane as a face-to-face transaction by separating payment guarantee from personal information.

Further, it is possible to surely prevent a commodity from being transferred to an unauthorized person by certifying the receiver for the commodity using the receiver certifying information, which has been previously communicated between the shop 2 and the customer 3, at the commodity transfer place 6 upon transfer of the commodity. Therefore it is possible to correct transferring of a commodity to an authorized receiver.

In the above-mentioned example, verifying the “receiver certifying information” is performed at the commodity transfer place 6 (by the receiver certifying terminal 61). Alternatively, the verification may of course be preformed at the shop 2 (by the shop's terminal 21). Namely, the information terminal 61 may make an inquiry to the shop 2 online as to whether the “receiver certifying information” input from the receiver-certifying-information inputting device 62 is correct or not. Using such an alternative verifying manner, since the commodity transfer place's terminal 61 does not necessitate a function of verifying, it is possible to realize the information terminal 61 reduced in cost.

Since the payment for the transaction is carried out between corporations by disposing the payment agent 4 between the customer 3 and the shop 2, the manner of payment may be performed by selecting various candidates, such as EDI (Electronic Data Interchange: in general, “inter-corporation e-commerce”) or a settlement by a draft, other than remitting from an account of the customer 2 as above-described. As a result, the shop 2 can reduce the labor in account. Further, since the payment is carried out between corporations, it is possible for the shop 2 to avoid attempting a fraud even if the shop 2 intends to.

Presumably, it is pointed out that the e-commerce method may be used for injustice because of the anonymous transaction. However, since the customer 3 is anonymous but the shop 2 is not. For example, the shop 2 cannot recognize identity of the customer 3 if the customer 3 is the police. As a result, it is possible to make the shop 2 discourage for selling illicit commodities because the shop 2 cannot grasp customer's identity.

In the illustrated example, the payment agent 4 arranges payment for the transaction to the shop 2 before the shop 2 makes arrangements to deliver the commodity. Alternatively, the arrangement of payment may be carried out when or after the shop 2 makes arrangements to deliver the commodity, or when or after the commodity is transferred to the customer 3.

Further, it is assumed that the customer 3 is identical with the receiver for the commodity. Alternatively, the customer 3 can purchase the commodity as a present (e.g., a Christmas present), and can designate, as the delivery destination, the commodity transfer place 6 (a convenience store, a branch office, a distribution place of the transportation company 5, etc.) which is located near to the residential place of the receiver of the present(e.g., a friend of the customer 3). When the commodity is a present, the “transaction number” and the “receiver certifying information” are notified the receiver of the present by e-mail, the mails, the telephones, fax, or etc.

In this case, since the shop 2 cannot also grasp personal information (address, name, telephone number, etc.) of the presenter (customer 3) and receiver, it is also impossible for the shop 2 to accumulate information about companionship between the presenter and it is possible to protect privacy of both the presenter and the receiver.

However, if the receiver for the commodity agrees that the shop 2 knows personal information (address, name, telephone number, etc.) of the receiver, the customer 3 (presenter) may designate the residential place of the receiver as the delivery destination of the commodity. In this case, since the shop does not know personal information of the customer 3, information about, at least, companionship of the customer 3 can be concealed.

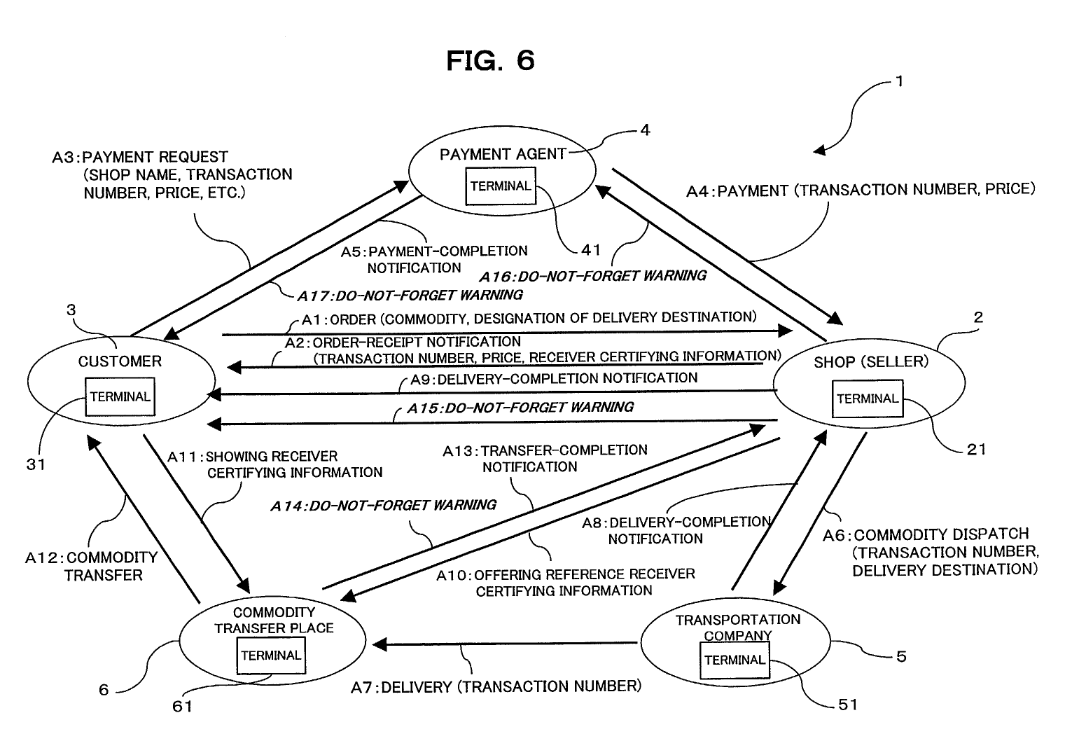

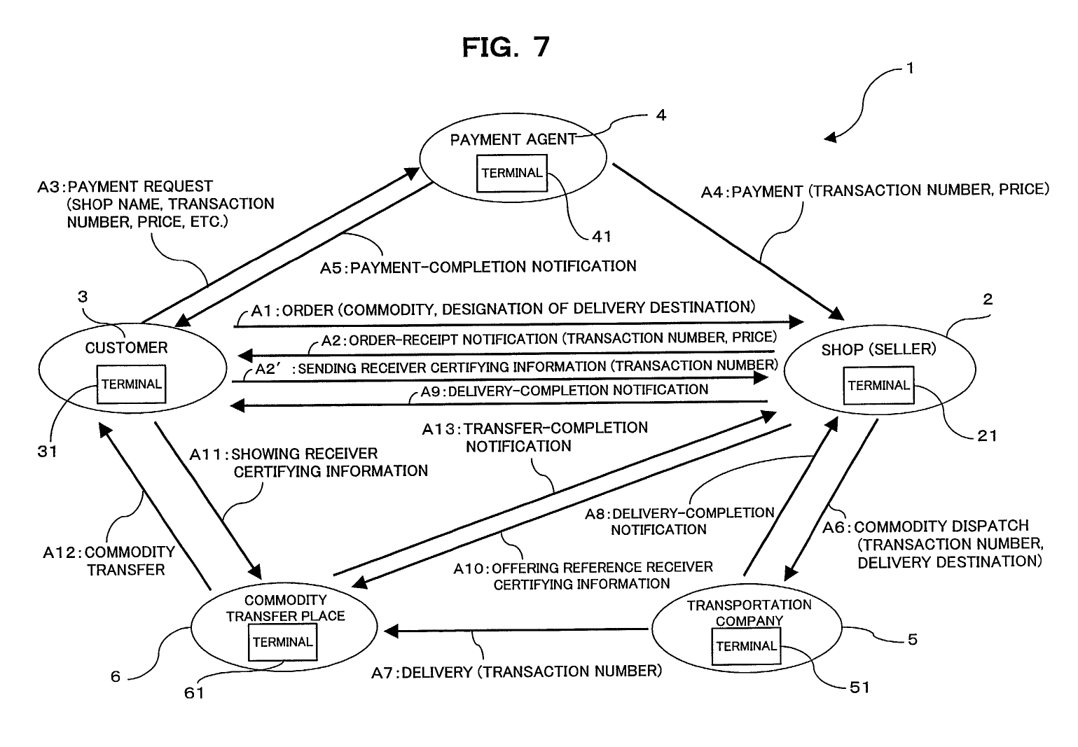

When the customer 3 forgets to receive the commodity, the commodity transfer place 6, as shown in FIG. 6, notifies the shop 2 of a do-not-forget warning (Step A14). Upon receipt of the do-not-forget warning, the shop 2 may notifies the customer 3 of a do-not-forget warning by e-mail or the like (Step A15). For notifying the customer 3, the shop 2 may simply forward the do-not-forget warning issued from the commodity transfer place 6, or may be created another do-not-forget warning different from the do-not-forget warning received therein. It is possible to prevent the commodity from being left at the commodity transfer place 6 for a long time caused by the customer's (3) forgetting to receive the commodity.

Despite of the do-not-forget warning, if the customer 3 does not come to receive the commodity, the shop 2 sends the payment agent 4 the “transaction number” as a do-not-forget warning (Step A16). Subsequently, the payment agent 4 may send a do-not-forget warning by a means other than e-mail (e.g., by the mails or by the telephone) (Step A17) with reference to personal information about the customer 3 (address, name, telephone number etc.) previously obtained by an agreement for establishing the account. With such warning manner, it is possible for the customer 3 to surely remind to receive the commodity when the customer 3 does not or cannot check e-mails.

Massages communicated between the customer 3 and the shop 2 via the network may be ciphered by use of the encryption technique, such as SSL (Secure Sockets Layer). With such technique, since the “transaction number” and “receiver certifying information” has little risk of leaking to a third person via the network, it is possible to further improve the security of the anonymous e-commerce.

In the illustrated embodiment, the “receiver certifying information” is created independently by the shop 2(the information terminal 21), and is notified the customer 3 by e-mail or other means so as to be previously communicated (defined) between the customer 3 and the shop 2. On the contrary, the customer 3 may create the “receiver certifying information” on the customer's own terms in accordance with a predetermined format (e.g., maximum number of reeds and usable characters of pass-word or pass-phrase) , whereupon the “receiver certifying information”, together with the “transaction number”, is notified the shop 2 by e-mail or other means (Step A2′) so as to be communicated (defined) likewise the illustrated example.

Since the customer 3 can designated any pass-word or pass-phrase memorable for the customer as the “receiver certifying information”, it is possible to improve the service to the customer 3.

As described later, if the commodity transfer place's terminal 61 has a function of certifying individual person with reference to biometrics data (e. g., such as fingerprint, palm print, finger shape, palm shape, voiceprint, iris code, blood vessel pattern, handwriting pressure, or keystroke), communicable with shop's terminal 21 via the network, the customer 3 may notify the shop 2 of biometrics data of the customer's own as the “receiver certifying information.

In this case, upon coming to the commodity at the commodity transfer place 6 to receive the commodity, the receiver for the commodity inputs to the commodity transfer place's terminal 61, together with the “transaction number”, the biometrics data identical with the data having been sent to the shop 2 for certifying the receiver and succeeding receiving the commodity. As a result, it is possible to realize extremely exact certification of the receiver for the commodity by using biometrics data. Since the owner of the biometrics data is hardly identified even if the biometrics data is sent to the shop 2, it is possible to protect privacy of the customer 3. Conversely, it does not necessitate to notifying biometrics data which can identify the individual person (e.g., portrait or dynamic signature).

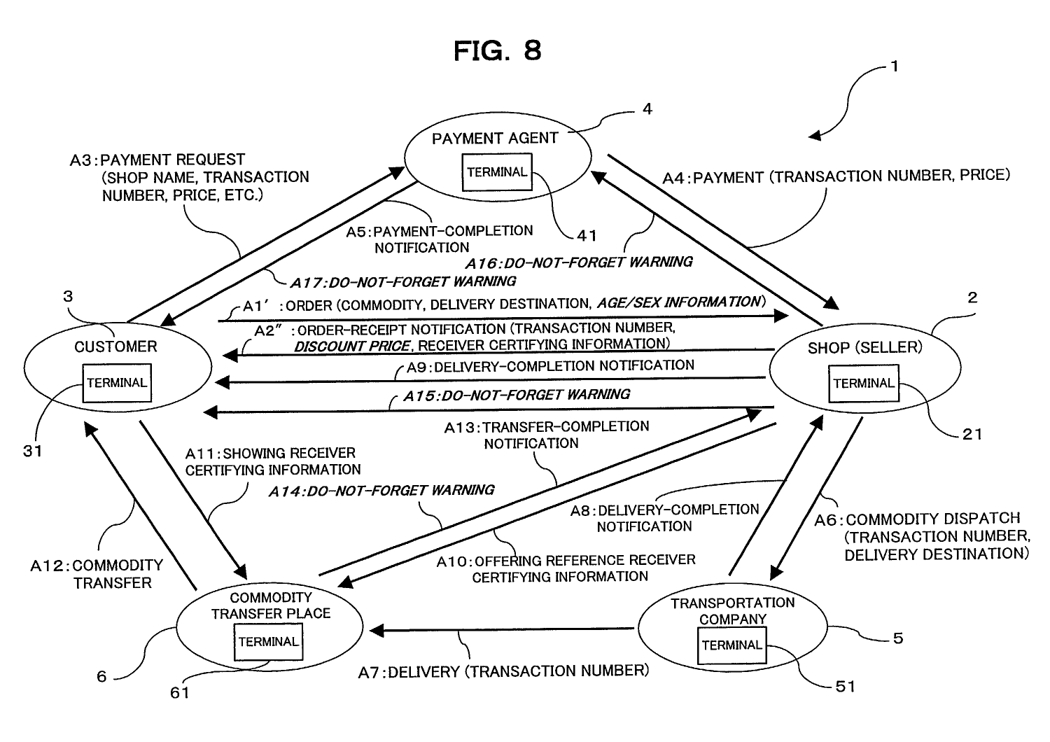

Further, as shown in FIG. 8, the customer 3 may notify the shop 2 of personal information from which it is impossible to identify individual person (e.g., sex, age, etc.), for example, by including it in the commodity-order data 11, and may conceal information of address, name, telephone number and set forth (Step Al′). It is possible for the shop 2 to make a discount for the purchased commodity of the customer 3 in return (Step A2″).

It is possible for the shop 2 to grasp a residential area, age, and sex of the customer 3 with reference with the commodity-order data 11, and to accumulate information as to which person would purchase which commodity. Namely, the customer 2 notifies the shop 2 of personal information from which it is impossible to identify individual person (e.g., sex, age, etc.) so as to cooperate the shop 2 in marketing business by providing marketing information necessary for commodity selling strategy. In return, the customer 3 can buy the commodity at a discount. Therefore, the customer 3 and the shop 2 can obtain benefit.

In this case, it is also possible to protect customer's privacy, such as address, name, and telephone number. Therefore the customer 3 can notify the shop 2 of personal information of age, sex or the like, without anxiety. It is expected that the customer 3 becomes more willing to purchase a commodity and the e-commerce is drastically enhanced.

Other marketing information provided the shop 2 from the customer 3 may be birthday and occupation, and, in terms of some commodity kinds, physical data (e.g., height, weight) could be effective marketing information for the shop 2.

The various procedures of previously making an agreement between the customer 3 and the payment agent 4 (for establishing a payment account) will now be described.

(A-1) First Instance of Establishing Account

In a first instance, the customer 3 opens an account in the payment agent 4 without disclosing the identity of the customer 3. The customer 3 requests the payment agent 4 to an establishment of a payment account, which is used for paying to the shop 2, by anonymous e-mail via customer's terminal 31 (Step B1), as shown in FIG. 9. Upon receipt of the e-mail, the payment agent 4 (the payment agent's terminal 41) opens the payment account whose number has not been used, whereupon the payment agent 4 notifies the customer 3 of the account number by an e-mail (Step B2).

The customer 3 deposits money in the payment account (Step B3), whose account number has been notified. When the payment agent 4 (the payment agent's terminal 41) confirms the deposit in the payment account (Step B4), the payment agent 4 creates an agreement code and customer (contractor) certifying information corresponding to the agreement code, and sends them to the customer 3 by an e-mail (Step B5).

The contractor certifying information may be a pass-word or a pass-phrase, and may be designated by the customer 3, not by the payment agent 4. The contractor certifying information with respect to the later-described instances may be in the same form.

After establishment of the payment account, the customer 3 requests the payment agent 4 for payment for the purchased commodity using the agreement code and the contractor certifying information. Then the payment agent 4 makes a direct debit of a price regarding the purchasing of the commodity in the payment account, which is identified by the agreement code, to make the payment to the shop 2.

In the illustrated instance, since it is possible for the customer 3 to establish the payment account by only notifying the payment agent 4 of e-mail address for communicating and to conceal other personal information, it is expected less opportunity for leaking personal information. Further, since, with suffice balance in the payment account in advance, the customer 3 does not have to deposit each time making a purchase of a commodity, it is possible to improve the service to the customer 3.

On the other hand, when the price regarding the purchasing of the commodity exceeds the balance in the payment account, the payment agent 4 may refuse to make the payment to the shop 2 or may request the customer 3 an additional deposit in the payment account. When the balance of the payment account becomes less than a predetermined sum, the payment agent 4 may request the customer 3 for an additional deposit in the payment account. In these circumstances, communication between the customer 3 and the payment agent 4 is performed by e-mail so that the customer 3 does not notify the shop 2 of the personal information (address, telephone number, etc.).

(A-2) Second Instance of Establishing Account

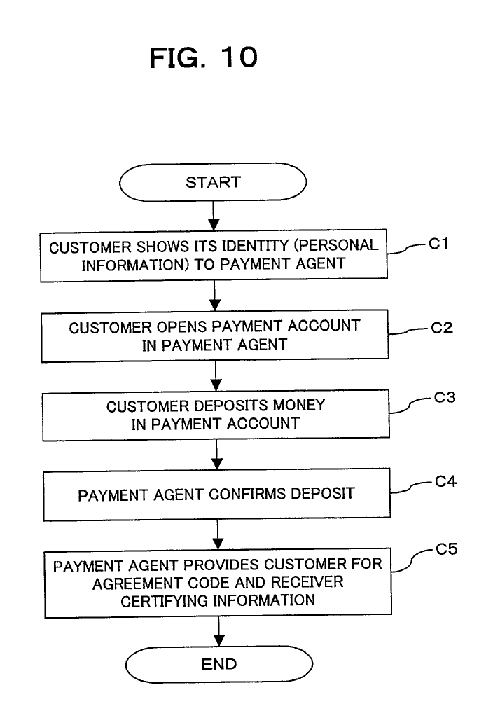

In a second instance, upon establishing a payment account, the customer 3 notifies the payment agent 4 of the customer's personal information, such as address, name, or telephone number. Specifically, first of all, the customer 3 provides the payment agent 4 with a procedure paper or form on which personal information (address, name, telephone number, etc.) necessary for arranging an agreement by human communicating over the counter or the mails, etc. (Step C1), as shown in FIG. 10. Then the payment agent 4 opens a payment account in the payment agent 4 (Step C2), whereupon the customer 3 deposits in the payment account (Step C3).

When the payment agent 4 (the payment agent's terminal 41) confirms the customer's deposit in the payment account (Step C4), the payment agent 4 creates an agreement code and contractor certifying information corresponding to the agreement code, and sends the customer 3 them by an e-mail, the mails or etc. (Step C5).

After the establishment the payment account, the customer 3 requests the payment agent 4 for payment for the purchased commodity using the agreement code and the contractor certifying information. Then the payment agent 4 makes a direct debit of the price regarding the purchasing of for the commodity in the payment account, which is identified by the agreement code, to make the payment to the shop 2.

Since, with suffice balance in the payment account individual in advance, the customer 3 does not have to deposit each time making of purchase of a commodity, it is possible improve the service to the customer 3 as the same advantageous result as the first instance. Further, knowing personal information of the customer 3, the payment agent 4 arranges payment for a commodity in behalf of the customer 3 with trust.

Also in this illustrated instance, when the price regarding the purchasing the commodity exceeds the balance in the payment account, the payment agent 4 may refuse to make the payment to the shop 2 or may request the customer 3 an additional deposit in the payment account.

In such circumstances, the payment agent 4 can notify the customer 3 by the mails or the telephones other than e-mail using the previously provided personal information (address, name, telephone number, etc.).

(A-3) Third Instance of Establishing Account

In a third instance, the customer 3 establish a payment account in the payment agent 4 and a predetermined amount of money is periodically (e.g., monthly) paid to the payment account by remitting from another account in a banking agency (hereinafter called a contracted account) previously opened by an agreement between the customer 3 and the banking agency.

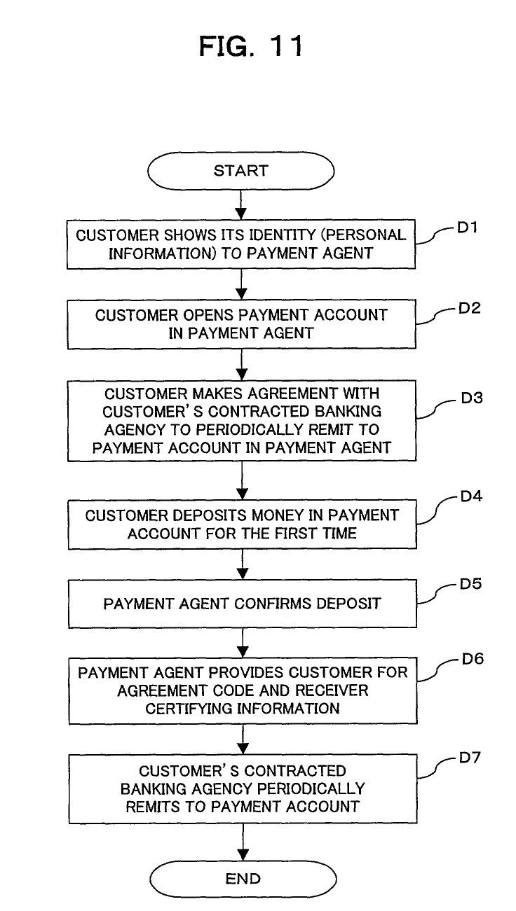

Specifically, first of all, the customer 3 provides the payment agent 4 with a procedure paper or form on which personal information (address, name, telephone number, etc.) necessary for arranging an agreement by communicating over the mails, human communication over the counter or other means (Step D1), as shown in FIG. 11. Then the payment agent 4 opens a payment account in the payment agent 4 (Step D2).

In succession, the customer 3 arranges another agreement with the baking agency to periodically remit a predetermined amount of money to the payment account from the contracted account (Step D3). After completion of the agreement, the first remittance (payment) to the payment account is carried out from the contracted account (Step D4). Upon confirmation of the first remittance (Step D5), the payment agent 4 (the payment agent's terminal 41) creates an agreement code and contractor certifying information corresponding to the agreement code, and sends them to the customer 3 by an e-mail, the mails or etc. (Step D6).

The predetermined amount of money is periodically paid (remitted) to the payment account in the payment agent 4 from the contracted account based on the agreement between the customer 3 and the banking agency (Step D7).

The customer 3 requests the payment agent 4 for payment of the purchased commodity using the agreement code and the contractor certifying information, which are notified by the payment agent 4, whereupon the payment agent 4 identifies the payment account with reference to the agreement code, and makes a direct debit of a price regarding the purchasing of the commodity in the payment account, to which the predetermined amount money is periodically remitted. The payment for the commodity to the shop 2 is accomplished thereby.

As the above-mentioned manner, the predetermined amount of money is periodically paid to the payment account in the payment agent 4 from the contracted account in the banking agency without a direction of the customer 3. Since the customer 3 does have to deposit in the payment account (make a request for payment for the purchased commodity) each time making a purchase of a commodity, it is possible to greatly improve the service to the customer 3.

Further, it is possible to reduce the possibility of lack of the balance in the payment account by setting proper amount of money to be periodically paid to the payment account. As a result, it is possible to improve confidence between the customer 3 and the shop 2 because of a reduced possibility in un-paying for the commodity.

On the other hand, when the price regarding the purchase of the commodity exceeds balance of the payment account, the payment agent 4 may refuse to make the payment to the shop 2 or may request the customer 3 an additional deposit or remittance in the payment account. When the balance of the payment account becomes less than a predetermined sum, the payment agent 4 may automatically request the customer 3 an additional deposit (remittance) in the payment account.

In such circumstances, the payment agent 4 can notify the customer 3 by the mails or telephones other than e-mail using the previously provided personal information (address, name, telephone number, etc.).

(A-4) Fourth Instance of Establishing Account

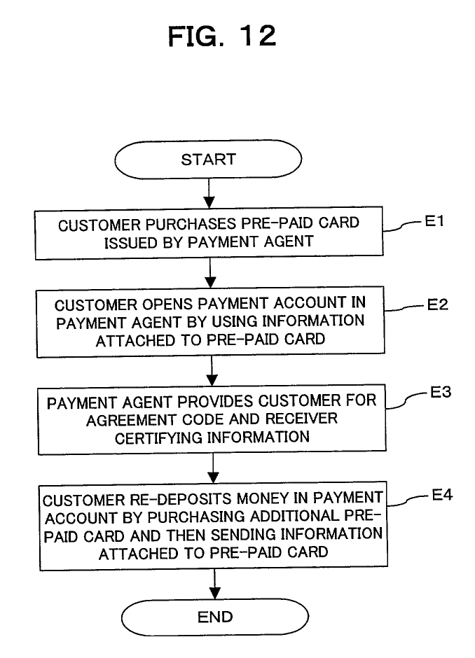

In the forth instance, the customer 3 establishes a payment account by purchasing a pre-paid card issued from the payment agent 4. First of all, as shown in FIG. 12, the customer 3 purchases a pre-paid card issued from the payment agent 4(Step E1), whereupon the customer 3 sends the payment agent 4 information attached to the pre-paid card by e-mail so as to open a payment account in the payment agent 4 (Step E2).

Subsequently, the payment agent 4 (the payment agent's terminal 41) creates an agreement code and contractor certifying information corresponding to the agreement code, and sends them to the customer by (returning) an e-mail (Step E3).

Once the payment account is established, the customer 3 purchases another pre-paid card, and send the payment agent 4 information attached to the pre-paid card so as to re-deposit additional money in the payment account (Step E4). In the illustrated instance, it is possible for the customer 3 to establish the payment account keeping personal information other than the e-mail address secret by informing the payment agent 4 of the e-mail address for communication.

The customer 3 requests the payment agent 4 for payment for the commodity using the agreement code and the contractor certifying information. Then the payment agent 4 makes a direct debit of a price regarding the purchasing of the commodity in a payment account, in which is re-deposited by pre-paid cards, identified by the agreement code, and makes the payment to the shop 2.

In the illustrated instance, when the price regarding the purchasing in the commodity exceeds the balance of the payment account, the payment agent 4 may refuse to make payment to the shop 2 or may request the customer 3 an additional deposit in the payment account. And when the balance in the payment account becomes less than a predetermined amount of money, the payment agent 4 may automatically request the customer 3 for additional deposit in the payment account.

(B) Second Embodiment

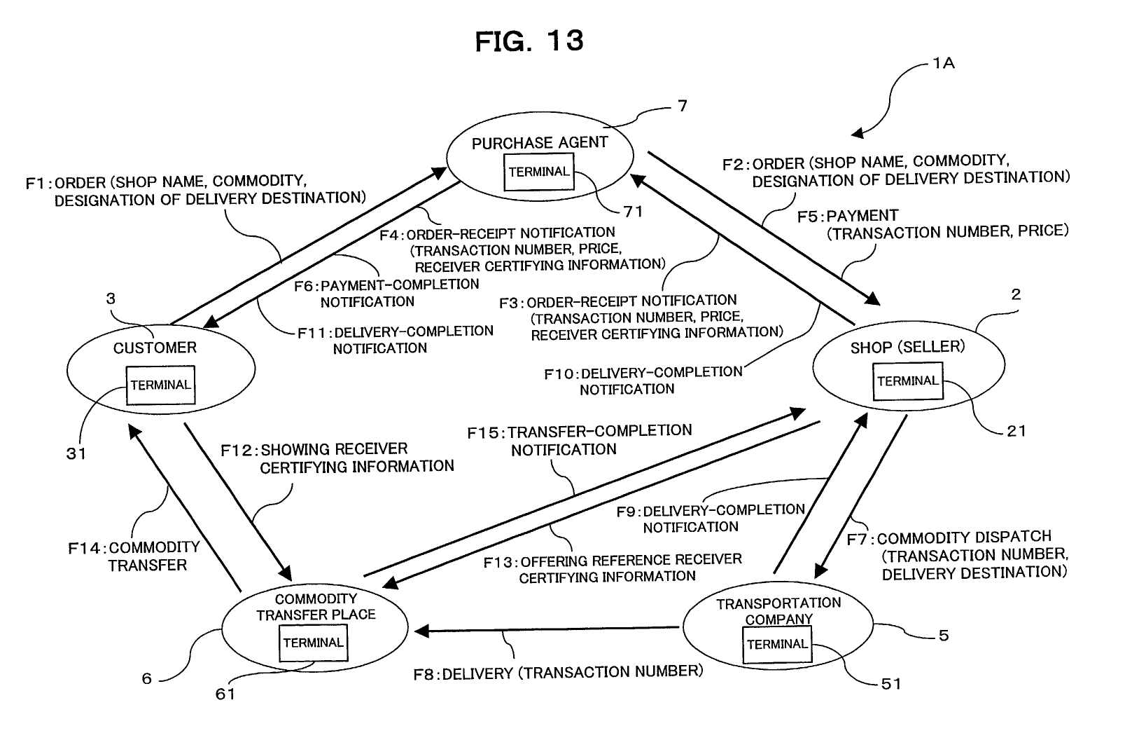

FIG. 13 is a diagram schematically showing an e-commerce method for an e-commerce system 1A according to a second embodiment. As a difference between the two e-commerce system of FIGS. 1 and 13, the e-commerce system 1A of FIG. 13 comprises a purchase agent 7, as substitution for the payment agent 4 for the e-commerce system 1 of FIG. 1, which is interposed between the customer 3 and the shop 2.

The purchase agent 7 is a corporation arranges a purchase of a commodity and a payment for the commodity in behalf of the customer 3. The purchase agent 7 is equipped with an information terminal 71 having functions of communicating information and being accessible to the network (e.g., the Internet), as a purchase agent's terminal. The purchase agent's terminal 71 is capable of communicating with the customer 3 or the shop 2 by e-mails, or etc. In the throughout this embodiment, the reference numbers already described are identical with those of the first embodiment unless additional description is made.

The e-commerce 1A having such configuration can also perform an anonymous e-commerce.

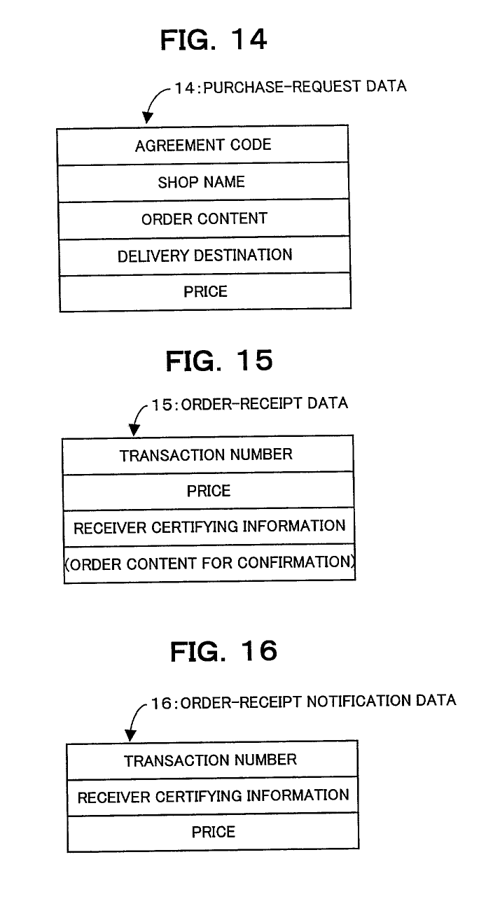

In the e-commerce method of the e-commerce system 1A, first of all, the customer 3 makes an access to the shopping site provided by the shop 2 on the Internet using customer's terminal 31. Subsequently, the customer 3 selects for a purchase commodity, whereupon the customer 3 sends an order for the selected commodity to the purchase agent 7 as a purchase-request data 14 by e-mail. As shown in FIG. 14,the purchase-request data 14 contains an “agreement code”, which has been provided by the purchase agent 7 based on the previous agreement, the “shop name” from which the customer 3 wishes to purchase a commodity, an “order content” (commodity name, quantity, etc.), and a “delivery destination”.

The customer 3 designates a non-residential place, such as a neighboring convenience store, a branch office (a distribution center) of the transportation company 5, or etc., other than a residential place of the customer 3 as the delivery destination (so far, Step F1; commodity-purchase request step). The “agreement code” is provided by establishing an agreement between the customer 3 and the purchase agent 7 (establishing a payment account) in such a manner described in the first embodiment (A-1 through A-4) with reference FIGS. 9 through 12.

Upon receipt of the purchase-request data 14, the purchase agent 7 (the purchase agent's terminal 71) sends an order to the shop's terminal 21 by notifying the shop 2 of the minimum information of the delivery destination and the order content by e-mail or other means (Step F2; commodity order step).

Upon receipt of the order, the shop 2 (the shop's terminal 21) notifies the purchase agent 7 of a order-receipt data 15, as shown in FIG. 15, containing a “transaction number” peculiar to the commodity order, a “price (sum) of the transaction” regarding the order of the commodity, and a “receiver certifying information” necessitated upon receiving the commodity, by (returning) an e-mail (Step F3; price information notifying step).

Upon receipt of the order-receipt data 15, the purchase agent 7 (the purchase agent's terminal 71) sends the customer 3 an order-receipt notification data 16, as shown in FIG. 16, containing at least the “transaction number” and the “receiver certifying information” by an e-mail or the like (Step F4). Further, the order receipt data 16 may contain the “price of the transaction” as shown in FIG.16.

In the meanwhile, likewise the first embodiment, the purchase agent 7 makes a direct debit of the “price (sum) of transaction” regarding the purchasing of the commodity in the payment account, whereupon the purchase agent 7 arranges the payment for the purchased commodity to the shop 2 using the “transaction number” (Step F5; payment step). At that time, the purchase agent 7 notifies the customer 3 of the completion of the payment by an e-mail or the like (Step F6).

Also in the illustrated embodiment, when the balance of the payment account becomes less than the payment for the commodity, the purchase agent 7 may refuse to make the payment to the shop 2 or may request the customer 3 an additional deposit in the payment account. When the balance of the payment account becomes less than a predetermined sum, the purchase agent 7 may automatically request the customer 3 for an additional deposit in the payment account.

Upon confirming the payment for the commodity, the shop 2 requests the transportation company 5 to deliver the commodity (Step F7). Then the commodity is delivered to the delivery destination designated by the customer 3 via the transportation system (Step F8; commodity delivery step). At that time, the shop 2 sends the delivery request (arrangement) to the transportation company 5 via e-mail using the shop's terminal 21, the telephones, human communication over the counter or etc.

The “delivery-completion notification” may be sent from the transportation company 5 to the customer 3 via the shop 2 or via the purchase agent 7 by an e-mail or the like (Steps F9 through F11). Upon receipt of the “delivery-completion notification” from the transportation company 5, the shop 2 may perform the “delivery-completion notification” for the customer 3 by notifying a status of delivery of individual commodity on the bulletin board on the shopping site, in the same manner as the first embodiment.

Since the “delivery-completion notification” prevents the customer 3 from going to the commodity transfer place 6 before the arrival of the commodity also in the illustrated embodiment, it is possible to greatly improve service to the customer 3.

Upon receipt of the “delivery-completion notification”, the customer 3 goes to the commodity transfer place 6 of the delivery destination to receive the commodity (commodity transfer step). Likewise the first embodiment, certification is made as to whether the receiver for the commodity is an authorized receiver using the “transaction number” and the “receiver certifying information”, which have been notified customer 3 by the shop 2 via the purchase agent 7.

Specifically, the customer 3 shows the “receiver certifying information” at the commodity transfer place 6 (Step F12), whereupon the“receiver certifying information” is compared with the reference “receiver certifying information” shown by the shop 2 (Step F13). When the two “receiver certifying information” are identical, it is judged that a person who showed the “receiver certifying information” is an authorized receiver, and the commodity is transferred to the authorized receiver (Step F14).

At that time, a “transfer-completion notification”, which notifies a normal completion of transferring the commodity, may be sent to the shop 2 by an e-mail or the like, via the network (online) (Step F15). As a result, it is possible for the shop 2 to grasp the status of transferring commodities without time delay. The “transfer-completion notification” in the form of an e-mail may be ciphered so as not to leak to a third person and so as to improve security. Alternatively, the “transfer-completion notification” may be sent to the shop 2 by the mails, the telephones, or etc. other than e-mail.

In the e-commerce method for the e-commerce 1A of the illustrated embodiment, the customer 3 makes the purchase agent 7 purchases the commodity in behalf of the customer 3. Partly since the delivery destination of the commodity is designated to the non-residential place of the customer 3 upon sending the order, partly since the payment for the commodity is arranged using the “transaction number”, which is separated from the personal information about the customer 3, it is possible for the customer 3 to accomplish the entire transaction without notifying the shop 2 of the personal information, same as the first embodiment.

Especially in the illustrated embodiment, since the purchase agent 7 arranges the commodity order and the payment for the commodity in behalf of the customer 3 so that the customer 3 does not directly communicate with the shop 2 during the entire transaction. As a result, it is possible to prevent the personal information of the customer 3 from being accumulated by the shop 2 because of a less possibility for the shop 2 of obtaining the personal information.

A technique of encryption may be used for the online communication between the customer 3 and the purchase agent 7 (purchase request, order-receipt notification, payment-completion notification, etc.), or the purchase agent 7 and the shop 2 (commodity order, order-receipt notification, payment, etc.). As a result, it is possible to further improve the security of e-commerce.

The customer 3 may purchase the commodity as a present, and may designate, as the delivery destination, the commodity transfer place 6 (a convenience store, a branch office/distribution place of the transportation company 5, etc.) which is located near to the residential place of the receiver of the present (e.g., a friend of the customer 3). If the receiver for the commodity (present) agrees that the shop 2 knows personal information of the receiver, the customer 3 (presenter) may designate the residential place of the receiver as the delivery destination of the commodity. In either case, it is possible to obtain the same advantageous result as the above-mentioned first embodiment.

When the customer 3 forgets to receive the commodity, the do-not-forget warning same as the first embodiment may be notified the customer 3 via the purchase agent 7. Therefore, it is possible to prevent the commodity from being left at the commodity transfer place 6 for a long time caused by the customer's (3) forgetting to receive the commodity.

Despite of the do-not-forget warning, if the customer 3 does not come to receive the commodity, it is also possible to warn the customer 3 from the purchase agent 7 with reference to personal information about the customer 3 (address, name, telephone number etc.), which is previously obtained by an agreement for establishing the account by means other than e-mail (e.g., the telephones, the mails). With such warning manner, it is possible for the customer 3 to surely remind to receive the commodity when the customer 3 does not or cannot check e-mails.

Also in the illustrated embodiment, the customer 3, not the shop 2, may create the “receiver certifying information” on customer's own in accordance with the format (e.g., maximum number of reeds and usable characters of pass-word or pass-phrase) designated by the shop 2. Subsequently, the “receiver certifying information” is notified the shop 2 via the purchase agent 7.

In this case, since the customer 3 can designate any “receiver certifying information” memorable for the customer 3, it is possible to improve the service to the customer 3.

Further, same as the first embodiment, if the commodity transfer place 6 is equipped with a terminal, communicable with shop's terminal 21 via the network, having a function of certifying individual person with reference to biometrics data, the customer 3 may notify the shop 2 of biometrics data of the customer's own as the “receiver certifying information.

Also in the illustrated example, the payment agent 4 arranges payment for the transaction to the shop 2 before the shop 2 makes arrangements to deliver the commodity. Alternatively, the arrangement of payment may be carried out other period, for example, when or after the shop 2 makes arrangements to deliver the commodity, or when or after the commodity is transferred to the customer 3.

Still further, the customer 3 may also provide the shop 2 with personal information (e.g., sex, age) which does not identify the customer 3 so that shop 2 make a discount of the price of the commodity purchased by the customer 3 in return.

(C) Third Embodiment

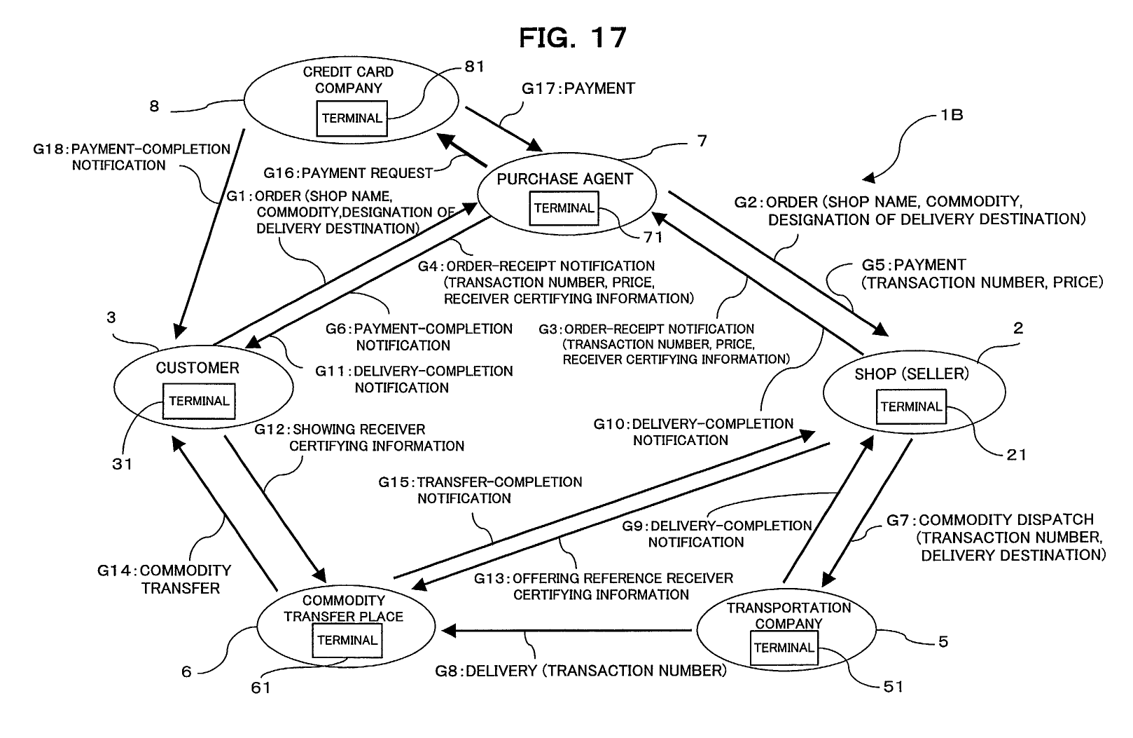

FIG. 17 is a diagram showing an e-commerce method for an e-commerce system 1B according to a third embodiment. As a difference between the two e-commerce system of FIGS. 13 and 17, the e-commerce system 1B of FIG. 17 further comprises a credit card company (settlement agent) 8.

The credit card company 8 has made an agreement with customer 3, and is equipped with an information terminal 81 having functions of communicating information and being accessible to the network (e.g., the Internet) as a settlement agent's terminal. The settlement agent's terminal 81 is capable of making an online transaction between at least the purchase agent 7.

It is possible to arrange the settlement regarding the commodity, which the customer 3 request the purchase agent 7 to purchase, between the credit card company 8 and the purchase agent 7 online (EDI: Electronic Data Interchange). Namely, in the illustrated embodiment, the purchase agent 7 charges the credit card company 8, which has made an agreement with the customer 3, for the price regarding the purchasing the commodity, which has been paid to the shop 2 by the purchase agent 7. Further, other reference number respectively designate same or similar part already described in the first and the second embodiments unless any additional description is made.

The anonymous e-commerce method for the e-commerce system 1B will now be described.

First of all, likewise the second embodiment, the customer 3 makes an access to the shopping site provided by the shop 2 over the Internet via customer's terminal 31. Subsequently, the customer 3 selects for a purchase commodity, whereupon the customer 3 sends an order for the selected commodity to the purchase agent 7 by sending an e-mail or the like, which containing “the name of a shop” from which the customer 3 wishes to purchase a commodity, an “order content” (commodity name, quantity, etc.), and a “delivery destination”.

The customer 3 designates a non-residential place, such as a neighboring convenience store, a branch office (a distribution center) of the transportation company 5, or etc. other than a residential place of the customer 3 as the delivery destination (so far, Step G1; commodity-purchase request step).

Upon receipt of the purchase request from the customer 3, the purchase agent 7 (the purchase agent's terminal 71) sends an order to the shop's terminal 21 by notifying the shop 2 of the minimum information of the delivery destination and the order content by e-mail or other means (Step G2; commodity order step).

Upon receipt of the order, the shop 2 (the shop's terminal 21) notifies the purchase agent 7 of a order-receipt data 15 (FIG. 15) containing a “transaction number” peculiar to the commodity order, a “price (sum) of the transaction” regarding the purchase of the commodity, and a “receiver certifying information” necessitated for receiving the commodity, by (returning) an e-mail (Step G3; price information notifying step).

Upon receipt of the order-receipt data 15, the purchase agent 7 (the purchase agent's terminal 71) sends to the customer 3 an order-receipt notification data 16 (FIG. 16) containing at least the “transaction number” and the “receiver certifying information” by an e-mail or the like (Step G4). Further, the order receipt data 16 may contain other information which does not identifies the customer 3, such as the “price of the transaction”.

In the meanwhile, the purchase agent 7 makes the payment in accordance with the price of the transaction to the shop 2 in behalf of the customer 3 (temporarily takes over the payment for the transaction) (Step G5; payment procuration step). Concurrently, the purchase agent 7 notifies the customer 3 of the completion of the payment by e-mail or the like (Step G6).

Upon confirming the payment for the transaction, the shop 2 requests the transportation company 5 to deliver the commodity (Step G7). Then the commodity is delivered to the delivery destination designated by the customer 3 via the transportation system (Step G8; commodity delivery step). At that time, the shop 2 sends the delivery request (arrangement) to the transportation company 5 by an e-mail using the shop's terminal 21, the telephones, human communication over the counter or etc.

A “delivery-completion notification” may be sent from the transportation company 5 to the customer 3 via the shop 2 and the purchase agent 7 by an e-mail or the like (Steps G9 through G11). Upon receipt of the “delivery-completion notification” from the transportation company 5, the shop 2 may perform the “delivery-completion notification” for the customer 3 by notifying a status of delivery of individual commodity on the bulletin board on the shopping site, in the same manner as the first embodiment.

Since the “delivery-completion notification” prevents the customer 3 from going to the commodity transfer place 6 before the arrival of the commodity also in the illustrated embodiment, it is possible to greatly improve service to the customer 3.

Upon receipt of the “delivery-completion notification”, the customer 3 goes to the commodity transfer place 6 of the delivery destination to receive the commodity (commodity transfer step). Likewise the first embodiment, certification is made as to whether the receiver for the commodity is an authorized receiver using the “transaction number” and the “receiver certifying information”, which have been notified customer 3 from the shop 2 via the purchase agent 7.

Specifically, the customer 3 shows the “receiver certifying information” at the commodity transfer place 6 (Step G12), whereupon the “receiver certifying information” is compared with the reference “receiver certifying information” shown by the shop 2 (Step G13). When the two “receiver certifying information” are identical, it is judged that a person who showed the “receiver certifying information” is an authorized receiver, and the commodity is transfer the authorized receiver (Step G14). Further, also in the illustrated embodiment, it is possible to surely prevent a commodity from being transferred to an unauthorized person by certifying the receiver for the commodity using the “receiver certifying information”, which has been previously communicated between the shop 2 and the customer 3. Therefore it is possible to correct and secure transferring of a commodity to an authorized receiver.

At that time, a “transfer-completion notification”, which notifies a normal completion of transferring the commodity, may be sent to the shop 2 by an e-mail or the like, via the network (online) (Step G15). As a result, it is possible for the shop 2 to grasp the status of transferring commodities without time delay. The “transfer-completion notification” in the form of an e-mail may be ciphered so as not to leak to a third person and so as to improve security. Alternatively, the “transfer-completion notification” may be sent to the shop 2 by the mails, the telephones, or etc. other than e-mail.

Meanwhile, the purchase agent 7 requests the credit card company 8 for payment for the price of the transaction, which has been temporarily taken over by the purchase agent 7 in Step G5 (Step G16; payment request step). At that time, if the purchase agent 7 knows personal information (e.g., the credit card number) of the customer 3 based on the previous agreement with the customer 3, the purchase agent 7 notifies the credit card company 8 of the credit card number.

Conversely, if the payment agent 7 does not know the credit card number of the customer 3, the payment agent 7 is notified of the credit card number corresponding to the “transaction number” from the customer 3. In this case, it is preferable that the credit card number is ciphered by use of the encryption technique. In alternative, the purchase agent 7 may notify the credit card company 8 of only the “transaction number”, and the customer 3 may notify the credit card company 8 of the “transaction number”, “agreement code”, or etc. Then the credit card company 8 may identify the credit card number corresponding to the “transaction numbers”.

Subsequently, the credit card company 8 makes a direct debit of the price regarding the transaction requested by the purchasing agent 7 in the customer's (3) banking account designated by the customer 3 based on a previous agreement so as to accomplish making the payment to the purchase agent 7 (Step G17; payment step), whereupon the credit card company 8 notifies the customer 3 of the payment completion by an e-mail, the mails, or etc. (Step G18).

The time when the settlement between the credit card company 8 and the purchase agent 7 can be carried out whenever after the completion of payment to the shop 2 from the purchase agent 7. It is preferable that the settlement is carried out at least after the customer 3 receives the “delivery-completion notification” because it may cause a trouble that the settlement is carried out before the customer 3 receives the commodity.

In the illustrated embodiment, thee-commerce system 1B comprises the credit card company 8 so that the credit card company 8 carries out the payment of the price regarding the transaction, which has been temporarily taken over by the purchase agent 7, to the purchase agent 7 in behalf of the customer 3. As a same result as the first and the second embodiments, it is possible for the customer 3 to accomplish e-commerce remaining anonymous to the shop 2, without establishing a payment account dedicated to settlement for e-commerce in the purchase agent 7.

Accordingly it is possible not only to attain same advantageous result as the first and the second embodiments but also to further improve the service to the customer 3. On the other hand, it is possible for the purchase agent 7 to carry out secure settlement and to avoid any trouble upon the settlement, since the credit card company 8 usually guarantees the identity of the customer 3. Furthers it is possible to reduce the purchase agent's labor in account. Since the payment is carried out between corporations, it is possible for the shop 2 and the purchase agent 7 to avoid attempting a fraud even if they intend to.

A technique of encryption may be used for the online communication between the customer 3 and the purchase agent 7 (purchase request, order-receipt notification, etc.), the purchase agent 7 and the shop 2 (commodity order, order-receipt notification, payment, etc.), or the credit card company 8 and the customer 3 or the purchase agent 7 (payment request, payment completion notification, etc.). As a result, it is possible to further improve the security of e-commerce.

The customer 3 may purchase the commodity as a present, and may designate, as the delivery destination, the commodity transfer place 6 (a convenience store, a branch office/distribution place of the transportation company 5, etc.) which is located near to the residential place of the receiver of the present (e.g., a friend of the customer 3). If the receiver for the commodity (present) agrees that the shop 2 knows personal information of the receiver, the customer 3 (presenter) may designate the residential place of the receiver as the delivery destination of the commodity. In either case, it is possible to obtain the same advantageous result as the above-mentioned first embodiment.

When the customer 3 forgets to receive the commodity, the do-not-forget warning same as the first embodiment may be notified the customer 3 via the purchase agent 7 or the credit card company 8. Therefore, it is possible to prevent the commodity from being left at the commodity transfer place 6 for a long time caused by the customer's (3) forgetting to receive the commodity.

Despite of the do-not-forget warning, if the customer 3 does not come to receive the commodity, it is also possible to warn the customer 3 from an intermediate (e.g., credit card company 8) which knows personal information about the customer 3 (address, name, telephone number etc.), which is previously obtained by an agreement for establishing the account, by means other than e-mail (e.g., the telephones, the mails). With such warning manner, it is possible for the customer 3 to surely remind to receive the commodity when the customer 3 does not or cannot check e-mails.

Also in the illustrated embodiment, the customer 3, not the shop 2, may create the “receiver certifying information” on customer's own in accordance with the format (e.g., maximum number of reeds and usable characters of pass-word or pass-phrase) designated by the shop 2. Subsequently, the “receiver certifying information” is notified the shop 2 via the purchase agent 7 by an e-mail or the like.

Also in this case, since the customer 3 can designate any “receiver certifying information” memorable for the customer 3, it is possible to improve the service to the customer 3.

Further, as the first embodiment, if the commodity transfer place 6 is equipped with a terminal, communicable with shop's terminal 21 via the network, having a function of certifying individual person with reference to biometrics data, the customer 3 may notify the shop 2 of biometrics data of the customer's own as the “receiver certifying information via the purchase agent 7.

Also in the illustrated example, the purchase agent 7 arranges payment for the transaction to the shop 2 before the shop 2 makes arrangements to deliver the commodity. Alternatively, the arrangement of payment maybe carried out other period, for example, when or after the shop 2 makes arrangements to deliver the commodity, or when or after the commodity is transferred to the customer 3.

Still further, the customer 3 may also provide the shop 2 with personal information (e.g., sex, age) which does not identify the customer 3 so that shop 2 make a discount of the price of the commodity purchased by the customer 3 in return.

(D) Fourth Embodiment

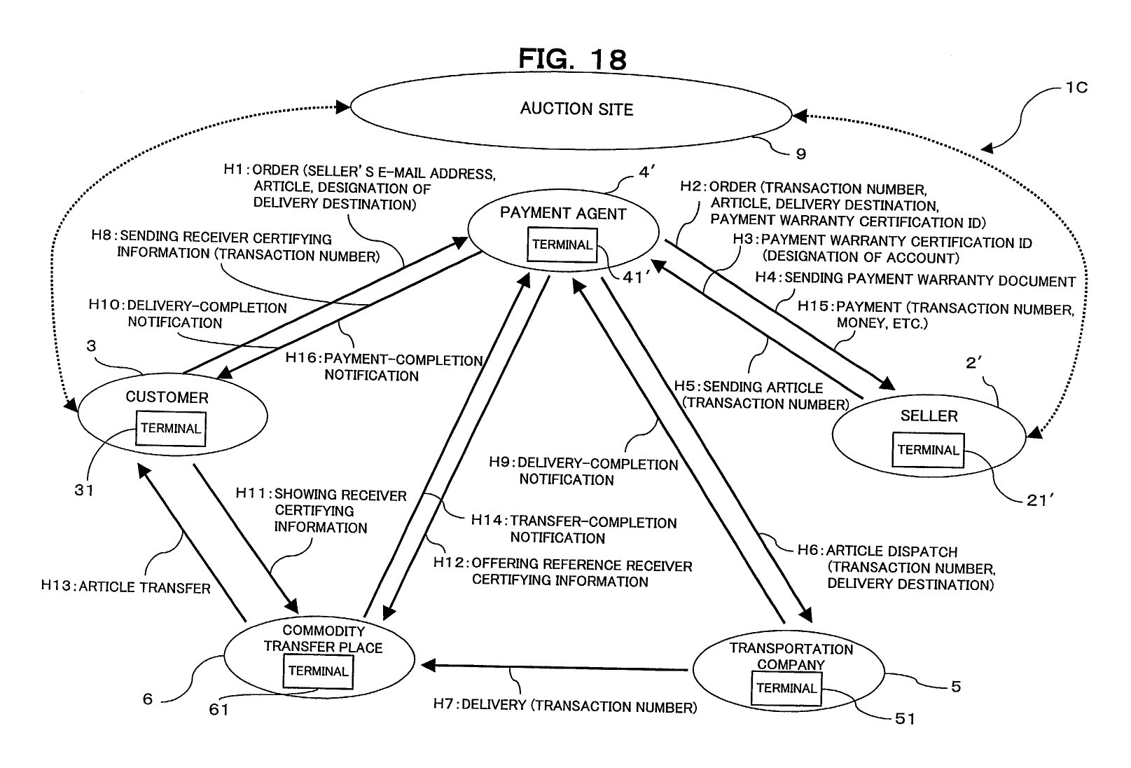

FIG. 18 is a diagram showing an e-commerce method for an e-commerce system according to a fourth embodiment. In the e-commerce system 1C of FIG. 18, an individual person, not the shop 2, sells a commodity and individual persons sell/purchase a commodity in an auction site 9 or a flea market site on the Internet. For e-commerce over the Internet, the home of the seller 2′ (hereinafter simply called the seller 2′) is also equipped with an information terminal (hereinafter also called the seller's terminal) 21′ having a function of communicating information and being accessible to the network, such as the Internet. In the throughout this example, the reference numbers already described are identical with those of the first through the third embodiments unless additional description is made.

The seller's terminal 21′ is also installed WEB browser software for browsing, for example, contents (WEB site, e.g., a homepage) established on the Internet (WWW) and e-mail software for allowing to sent/receive e-mail, as the above-mentioned function of communicating information. As a result, when a demand arises, the information terminal 21′ enables its user to browse a WEB site (contents) and to send/receive e-mail among other information terminals, over the Internet. The seller 2′ put a commodity on the auction site 9 using the seller's terminal 21′.

In thee-commerce system 1C, the payment agent 4′ is disposed between the customer 3 and the seller 2′. The payment agent 4′ is equipped with an information terminal 41′ having a function of communicating information and being accessible to the network, such as the Internet. The payment agent 4′ in the e-commerce system 1C warrants the seller 2′ that the customer 3 makes the payment to the seller 2′ relating to the purchase of a commodity by the customer 3.

The e-commerce method for the e-commerce system 1C in the illustrated embodiment will now be described. It is assumed that the customer 3 has knocked down the commodity put on the auction site 9 by the seller 2′ and has known at least an e-mail address of the seller 2′ resulted from communication on the auction site 9. A payment account is established in the payment agent 4′ by any one of the manners of arranging an agreement respectively described with reference to FIGS. 9 through 12 (A-1 through A-2) so that the customer 3 can accomplish e-commerce.

First of all, the customer 3 (the customer's terminal 31) requests the payment agent 4′ to warrant the payment relating to the commodity knocked down on the auction site 9 by an e-mail or the like. At that time, the customer 3 notifies the payment agent 4′ of the e-mail address of the seller 2′, the “name of the knocked-down commodity”, the designated “delivery destination of the knocked-down commodity”. The customer 3 designates a non-residential place of the customer 3, such as a neighboring convenience store, a branch office (a distribution center) of the transportation company 5, or etc., as the delivery destination (commodity transfer place 6) (so far, Step H1; delivery request step).

Upon receipt of the delivery request, the payment agent 4′ (the payment agent's terminal 41′) creates a “transaction number” (transaction identification information) peculiar to the delivery request, whereupon the payment agent 4′sends the “name of the commodity” to be deliver to the customer 3, the delivery destination designated by the customer 3, and “payment warranty certifying identification (ID) used for seller's certification of the payment warranted by the payment agent 4′by e-mail or other means (Step H2).

The seller 2′ (the seller's terminal 21) returns the payment agent 4′ the “payment warranty certifying ID” by e-mail or other means (Step H3), and then receives a “payment warranty document” in the form of an electronic document from the payment agent 4′ by e-mail or other means (Step H4). Additionally, the seller 2′ may designate the method of payment for the transaction. If the payment is carried out by remitting in an account, the seller 2′ notifies the payment agent 4′ of the account of seller 2′. The payment agent 4′ notifies its address by attaching to the “payment warranty document”, or by another e-mail.

The seller 2′ prints the received “payment warranty document” out, and sends the printed “payment warranty document”, together with the commodity knocked down by the customer 3, to the payment agent 4′ with reference to the notified address. At that time, the “transaction number” is also sent to the payment agent 4′ together with the commodity (Step H5).

The payment agent 4′ request the transportation company 5 to delivery the commodity received from the seller 2′ (Step H6), whereupon the commodity is delivered to the delivery destination (commodity transfer place) 6 designated by the customer 3 via the transportation system (Step H7; commodity delivery step). In the meantime, the payment agent 4′ notifies the customer 3 of the “transaction number” and the “receiver certifying information” by e-mail or the like (Step H8). The payment agent 4′ may request the transportation company 5 to deliver the commodity using the payment agent's terminal 41′ by e-mail, or the telephones.

Upon completion of the delivery, the transportation company 5 notifies the payment agent 4′ of the completion of the delivery (Step H9), and then the payment agent 4′ sends the customer 3 a “delivery-completion notification” by an e-mail or the like (Step H10). As a substitution for sending the “delivery-completion notification”, information about delivery status in accordance with each “transaction number” may be displayed on a bulletin board (information bulletin means) on the auction site so that the customer 3 occasionally accesses to the bulletin board to make a notice on the delivery status of the commodity. In either case, partly since the customer 3 can grasp the status of delivery for the commodity, partly since the customer 3 can avoid going to the commodity transfer place 6 before the arrival of the commodity, it is possible to greatly improve the service to the customer 3.

Upon receipt of the “delivery-completion notification”, the customer 3 goes to the commodity transfer place 6 to receive the commodity. At that time, certification is made as to whether the receiver for the commodity is an authorized receiver using the “transaction number” and the “receiver certifying information” (commodity transfer step).

The customer 3 shows the “receiver certifying information”, which have been previously notified by the payment agent 4′, at the commodity transfer place 6 (Step H11), whereupon the “receiver certifying information” is compared to a reference “receiver certifying information” provided by the payment agent 4′ (Step H12). When the both certification information are identical, it is judged the customer 3 to be an authorized receiver for the commodity and the commodity is transferred to the customer 3 (Step H13). Therefore since it is possible to surely prevent the commodity from being transferred to an unauthorized person, the secure and correct transfer of the commodity can be realized.

A “transfer-completion notification”, which notifies a normal completion of transferring the commodity, may be sent to the payment agent 4′ (Step H14) together with the “transaction number”. If the “transfer-completion notification” is sent to the seller 2′ by an e-mail, it is possible for the payment agent 4′ to grasp the status of transfer of the commodity without time delay. The “transfer completion notification” in the form of an e-mail may be ciphered so as not to leak to a third person and so as to improve security. Alternatively, the “transfer-completion notification” may be sent to the payment agent 4′ by the mails, the telephones, or etc. other than e-mail.

Upon receipt of the “transfer-completion notification” and the “transaction number”, the payment agent 4′ identifies the designated account of the seller 2′, which the payment agent 4′ has warranted the payment, based on the “transaction number”. The payment agent 4′ makes a direct debit of a price regarding the purchasing of the commodity in the customer's (3) payment account, and arranges remittance (payment) to the designated account of the seller 2′ (Step H15). At that time, the “transaction number” is also used so that the seller 2′ can identifies the remittance corresponding to which transaction (commodity).

Subsequently, the payment agent 4′ notifies the seller 2′ of the completion of arranging payment by e-mail, the telephones, the mails, or etc. (Step H16).

In the e-commerce method of the e-commerce system 1C, the customer 3 requests the payment agent 4′ to deliver the commodity to the commodity transfer place 6, which is a non-residential place of the customer 3, as the designated delivery destination, and the commodity is delivered to the commodity transfer place 6 designated by the customer 3 after the payment agent 4′ warrants the payment to the sell 2, which purchase is identified by the “transaction number” peculiar to the deliver request, by the electronic document. As a result, the commodity is transferred to the customer 3 remaining the personal information of the customer 3 secret from the seller 2′, and it is possible to avoid pecuniary trouble, such that the payment to the seller 2′ is not made despite of the commodity delivery.

In the illustrated embodiment, since the payment is arranged after the payment agent 4′confirms the transfer of the commodity to the customer 3, it is possible to avoid making arrangements to pay for the commodity when the receiver 3 does not receive the commodity. It is also possible for the seller 2′ to avoid attempting an iniquity, such as a fraud.

As a result, it is possible to realize the secure and exact transfer of a commodity and money also between individual persons on the auction site 9 (or a flea market site).

A technique of encryption may be used for the online communication between the customer 3 and the payment agent 4′ (delivery request, payment-completion notification, etc.), or the payment agent 4′ and the seller 2′ (commodity order, payment, etc.). As a result, it is possible to further improve the security of e-commerce.

The customer 3 may purchase the commodity as a present, and may designate, as the delivery destination, the commodity transfer place 6 (a convenience store, a branch office/distribution place of the transportation company 5, etc.) which is located near to the residential place of the receiver (e.g., a friend of the customer 3) of the present. If the receiver for the commodity (present) agrees that the shop 2 knows personal information of the receiver, the customer 3 (presenter) may designate the residential place of the receiver as the delivery destination of the commodity. In either case, it is possible to obtain the same advantageous result as the above-mentioned first embodiment.

When the customer 3 forgets to receive the commodity, the do-not-forget warning same as the first embodiment may be notified the customer 3 via the payment agent 4′. Therefore, it is possible to prevent the commodity from being left at the commodity transfer place 6 for a long time caused by the customer's (3) forgetting to receive the commodity.

Despite of the do-not-forget warning, if the customer 3 does not come to receive the commodity, it is also possible to warn the customer 3 from the payment agent 4′ with reference to personal information about the customer 3 (address, name, telephone number etc.), which is previously obtained by an agreement for establishing the account by the telephones, the mails or etc. other than e-mail. With such warning manner, it is possible for the customer 3 to surely remind to receive the commodity when the customer 3 does not or cannot check e-mails.

Also in the illustrated embodiment, the customer 3, not the payment agent 4′, may create the “receiver certifying information” on customer's own in accordance with the format (e.g., maximum number of reeds and usable characters of pass-word or pass-phrase) designated by the payment agent 4′. Subsequently, the “receiver certifying information” is notified the seller 2′ via the payment agent 4′ by an e-mail or the like.

Also in this case, since the customer 3 can designate any “receiver certifying information” memorable for the customer 3, it is possible to improve the service to the customer 3.

Further, same as the first embodiment, if the commodity transfer place 6 is equipped with a terminal, communicable with payment agent's terminal 41′ via the network, having a function of certifying individual person with reference to biometrics data, the customer 3 may notify the payment agent 4′ of biometrics data of the customer's own as the “receiver certifying information.

In alternative, under a warranty that the payment agent 4′ delivers the commodity without fail, the payment relating to the purchasing the commodity to the seller 2′ may be arranged when the payment agent 4′ receives the commodity from the seller 2′. At that time, the seller 2′ may directly request the transportation company 5 to deliver the commodity. But, for the secure e-commerce, it is preferable that the delivery request from the seller 2′ is carried out at least after the seller 2′ confirms the “payment warranty” from the payment agent 4′by receiving the “payment warranty document”.

(E) Fifth Embodiment

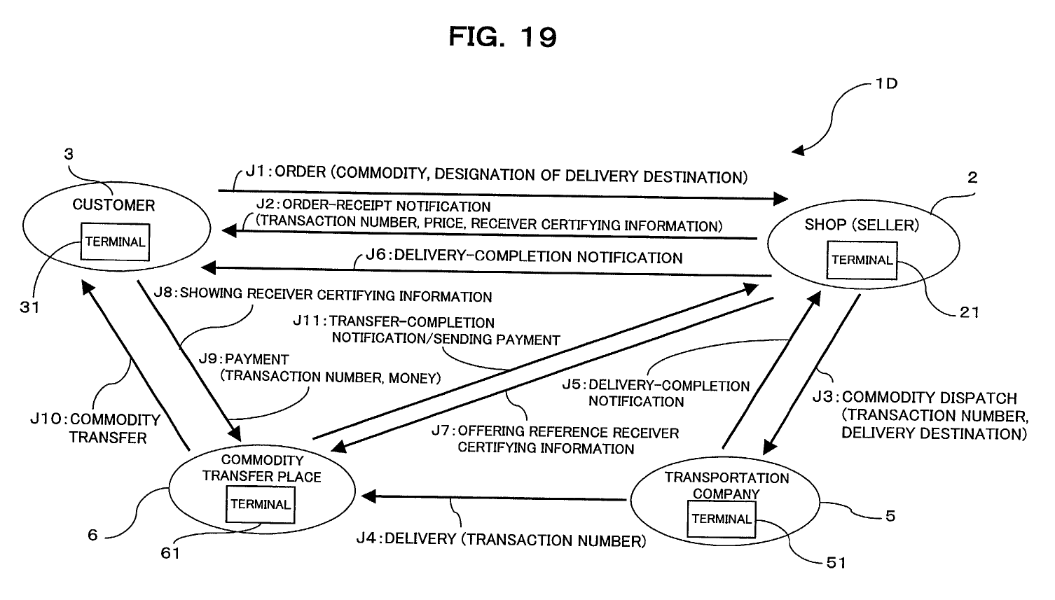

FIG. 19 is a diagram showing an e-commerce method for an e-commerce system according to a fifth embodiment. As a different point between the two e-commerce system of FIGS. 1 and 19, the e-commerce system 1D of FIG. 19 does not include the payment agent 4. Namely, the e-commerce system 1D comprises a shop 2, a customer 3, a transportation company 5, and a commodity transfer place 6, respectively equipped with information terminals 21, 31, 51, 61 as a shop's terminal, a customer's terminal, a transportation company's terminal, and a commodity transfer place's terminal.

Each of various information terminals 21, 31, 51, 61 is installed WEB browser software for browsing, for example, contents (WEB site, e.g., a homepage) established on the Internet (WWW) as a function of communicating information being accessible to the network, such as the Internet, and is installed e-mail software for allowing to sent/receive e-mail, as the above-mentioned function of communicating information. As a result, when a demand arises, each of various information terminals 21, 31, 51, 61 enables its user to browse a WEB site (contents) and to send/receive e-mail among other information terminals, via the Internet.

The functions and the behaviors of the information terminals 21, 31, 51, 61 are substantially identical with those of the first embodiment.

An anonymous e-commerce method of the e-commerce system 1D will now be described.

First of all, the customer 3 makes an access to the shopping site provided by the shop 2 on the Internet via customer's terminal 31. Subsequently, the customer 3 selects for a purchase commodity, whereupon the customer 3 sends an order for the selected commodity to the shop 2 by sending an e-mail for the order, or filling out an order form previously prepared by the shop 2 and sending the form back to the shop 2.

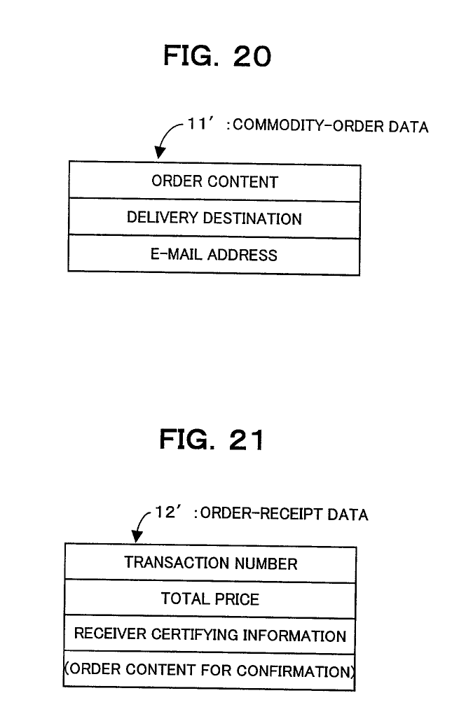

At that time, the customer 3 sends only minimum (commodity-order) data 11′ of “order content” (commodity name, quantity, etc.), “delivery destination for the commodity”, and “e-mail address”, as shown in FIG. 20. The customer 3 designates a non-residential place other than a residential place of the customer 3 as the “delivery destination for commodity” so as to keep the residential place of the customer 3 secret. The customer 3 designates a neighboring convenience store, a branch office (a distribution center) of the transportation company 5, a post-office box, and etc. as the delivery destination. Namely, the customer 3 sends the shop 2 the order remaining anonymous to the shop 2 (Step J1; order sending step).

Upon receipt of the order, the seller's terminal 21 automatically creates “transaction number” for identifying the transaction, and “receiver (customer) certifying information” for being used upon transferring the commodity. The “transaction number” and the “receiver certifying information” are numbers and information peculiar to the transaction. The “transaction number” and the “receiver certifying information”, together with “total price” of the transaction, are notified to the customer 3 in the form of order-receipt notification data 12′ (FIG. 21) via the network (Step J2; transaction identification (ID) information notifying step).

The order-receipt notification data 12′ may include information for confirming the order content, as shown in FIG. 21. Further, the order-receipt notification data 12 may be send to the customer 3 by e-mail or may be noticed on a bulletin board noticeable only by the customer 3 on the WEB site as a order-receipt notification screen.

The shop 2 requests the transportation company 5 to make arrangements to deliver the ordered commodity (Step J3), whereupon the commodity is delivered to the delivery destination (the commodity transfer place) 6 designated by the customer 3 (Step J4; commodity delivery step), via the transportation system. The delivery request (arranges) from the shop 2 to the transportation company 5 may be arranged by an e-mail using the shop's terminal 21, the telephones, or human communication over the counter.

Upon completion of the delivery, the transportation company 5 notifies the shop 2 of the completion of the delivery (Step J5), and then the shop 2 sends the customer 3 a “delivery-completion notification” by an e-mail or the like (Step J6). Since the “delivery-completion notification” prevents the customer 3 from going to the commodity transfer place 6 before the arrival of the commodity, it is possible to greatly improve service to the customer 3.

Alternatively, information about delivery status in accordance with each “transaction number” may be displayed on a bulletin board (information bulletin means) in the shopping site as the “delivery-completion notification” so that the customer 3 occasionally accesses to the bulletin board to make a notice on the delivery status of the customer's purchased commodity. Partly since the customer 3 can grasp the delivery status of the commodity, partly since the customer 3 also avoid going to the commodity transfer place 6 before the arrival of the commodity, it is possible to greatly improve service to the customer 3.

Upon receipt of the “delivery-completion notification”, the customer 3 goes to the commodity transfer place 6 to receive the commodity. At that time, certification is made as to whether the receiver for the commodity is an authorized receiver by use of the “transaction number” and “receiver certifying information” so that it is possible to realize secure and correct transfer of the commodity. And the payment for the commodity is arranged using the “transaction number” (commodity transfer step).

Specifically, the customer 3 shows the “receiver certifying information”, which have been previously notified by the shop 2, at the commodity transfer place 6 (Step J8), whereupon the “receiver certifying information” is compared to a reference “receiver certifying information” provided by the shop 2 (Step J7). When the both certification information are identical, it is judged the customer 3 to be an authorized receiver for the commodity.

If it is judged the customer 3 to be an authorized receiver for the commodity, the customer makes arrangement of the payment for the commodity on the spot to receive the commodity (Steps J9, J10). Generally, the customer 3 pays for cash. The commodity transfer place 6 sends the shop 2 a “transfer-completion notification”, which notifies a normal completion of transferring the commodity, together with the received payment for the commodity in the form of a registered mail or etc. (Step J11). At that time, the commodity transfer place 6 has to send also the “transaction number” so that it is possible for the shop 2 to recognize that the payment corresponds to which transaction.

The “transfer-completion notification” for individual commodity is sent to the shop's terminal 21 of the shop 2 by e-mail or the like via the network. As a result, it is possible for the shop 2 to grasp the status of transferring commodities without time delay. The “transfer-completion notification” in the form of an e-mail may be ciphered so as not to leak to a third person and so as to improve security. Alternatively, the “transfer-completion notification” may be sent to the shop 2 by the mails, the telephones, or etc., which are other than e-mail.

In the above-mentioned e-commerce system 1D, without the presence of the intermediate agents (e.g., the payment agent 4, the purchase agent 7, the credit card company 8), the customer 3 sends an order for the commodity and designates the commodity transfer place 6 other than the residential place as the delivery destination, and makes arrangements of the payment for the commodity using the “transaction number”, which has been provided by the shop 2, at the commodity transfer place 6. As a result, the customer 3 can carry out the entire transaction of sending an order, making payment, and receiving a commodity, without notifying the shop 2 of personal information of the customer 3.

Also in the illustrated embodiment, it is possible to prevent the personal information (privacy) of the customer 3 from being accumulated by the shop 2. Further, as a concise point, the customer 3 can accomplish the purchasing the commodity without establishing an agreement with an intermediate agent because of the absence of an intermediate agent.

As a potential demerit point, since the customer 3 is anonymous to the shop 2 in addition to the absence of an intermediate agent for warranting the payment for the commodity, the shop 2 has to take all the risk of the payment for the commodity. Whereas, in the conventional online transactions and mail orders, the shop 2 request the customer 3 to notify of the personal information of the customer 3 (e.g., address, name, telephone number) as a warranty for payment.

Massages communicated between the customer 3 and the shop 2 via the network may be ciphered by use of an encryption technique, such as SSL (Secure Sockets Layer). It is possible to further improve the security of the anonymous e-commerce.

The customer 3 may purchase the commodity as a present, and may designate, as the delivery destination, the commodity transfer place 6 (a convenience store, a branch office, a distribution place of the transportation company 5, etc.) which is located near to the residential place of the receiver (e.g., a friend of the customer 3) of the present. If the receiver for the commodity (present) agrees that the shop 2 knows personal information of the receiver, the customer 3 (presenter) may designate the residential place of the receiver as the delivery destination of the commodity. In either case, it is possible to obtain the same advantageous result as the above-mentioned first embodiment.

When the customer 3 forgets to receive the commodity, the do-not-forget warning same as the first embodiment may be notified the customer 3. Therefore, it is possible to prevent the commodity from being left at the commodity transfer place 6 for a long time caused by the customer's (3) forgetting to receive the commodity.

Also in the illustrated embodiment, the customer 3, not the shop 2, may create the “receiver certifying information” on customer's own in accordance with the format (e.g., maximum number of reeds and usable characters of pass-word or pass-phrase) designated by the shop 2. Subsequently, the “receiver certifying information” is notified the shop 2 by the customer 3.

In this case, since the customer 3 can designate any “receiver certifying information” memorable for the customer 3, it is possible to improve the service to the customer 3.

Further, as the first embodiment, if the commodity transfer place 6 is equipped with a terminal, communicable with shop's terminal 21 via the network, having a function of certifying individual person with reference to biometrics data, the customer 3 may notify the shop 2 of biometrics data of the customer's own as the “receiver certifying information.

Still further, the customer 3 may also provide the shop 2 with personal information (e.g., sex, age) which does not identify the customer 3 so that shop 2 make a discount of the price of the commodity purchased by the customer 3 in return.

(F) Modifications of Delivery/Transfer of a Commodity

The manner of delivery/transfer of a commodity (the manner of certifying an authorized receiver for the commodity at the commodity transfer place 6; i.e., the manner of certifying a pair of the “transaction number” and the “receiver certifying information”) throughout the above-mentioned embodiments may take various modifications. The modifications will now be described.

(F-1) First Modification

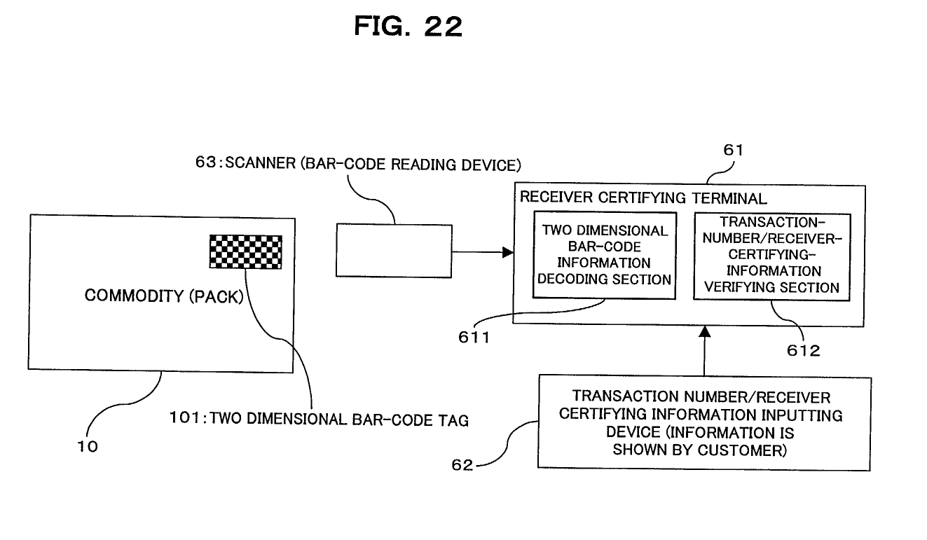

In the illustrated modification, the commodity transfer place's terminal 61 (hereinafter also called a receiver-certifying terminal), which is installed in the commodity transfer place 6, includes a two dimensional bar-code information decoding section 611 and a transaction-number/receiver-certifying-information verifying section 612, and also has a function of certifying receiver, as shown in FIG. 22. The shop 2 attaches a bar-code tag (slip medium) 101 containing the “transaction number” and the “receiver certifying information” in the form of a two dimensional bar-code (hereinafter simply called a bar-code) to the package of the commodity (pack) 10. Then, the commodity is delivered to the commodity transfer place 6 via transportation system.

The “two dimensional bar-code” is the same kind as a “bar-code” generally used at checkout counter in a supermarket or the like. In the general bar-code, a plurality of lines having respective thickness are arranged in the same direction (one dimension). Conversely, the “two dimensional bar-code” is digital data in the form of a two-dimensional dotted pattern, and is exemplified by “INTACTA. CODE™”.

At the commodity transfer place 6, the bar-code tag 101 is read by a scanner (a bar-code (slip medium) reading device) 63, which is installed in the receiver certifying terminal 61, and the read bar-code information is inputted to the receiver certifying terminal 61. The “receiver certifying information” shown by the customer 3 is input to the receiver certifying terminal 61 via a transaction-number/receiver-certifying-information inputting device 62.

The transaction-number/receiver-Certifying-information inputting device 62 may be a keyboard installed in the receiver certifying terminal 61, or, if the customer 3 restores the “transaction number” and the “receiver certifying information” also in the form of the bar-code, may be a scanner. The scanner may be in the form of an installation type and a mobile type (e.g., a pan-shape type).

The information on the bar-code is decoded by the two dimensional bar-code information decoding section 611 in the receiver certifying terminal 61, thereby the “transaction number” and the reference “receiver certifying information” are restored. Then, the “transaction number” and the “receiver certifying information” on the bar-code tag 101 are compared to the reference “transaction number” and the reference “receiver certifying information”, which are input from the receiver-certifying information inputting device 62, for verification in the transaction-number/receiver-certifying information verifying section 612.

When the both sets of the “transaction number” and the “receiver certifying information” are identical, it is judged that the customer 3 is an authorized receiver for the commodity and the commodity is transferred to the customer 3.

Since certification is made as to whether the customer 3 is an authorized receiver by using the “transaction number” and the “receiver certifying information” in the form of two dimensional bar-code, it is possible to realize an exact and speedy certification with ease reducing possible human mistake compared to a conventional certifying manner of showing an identification card (e.g., driver's license). Further, since the labor can be streamlined upon transfer of a commodity at the commodity transfer place 6, it is possible to reduce the cost for hire due to a reduced number of working people.

In alternative, the verification of the “receiver certifying information” may be carried out at the shop 2 (the shop's terminal 21) online. As a result, it is possible to realize the entire e-commerce system low in cost because the receiver certifying terminal 61 requires reduced functions.

(F-2) Second Modification

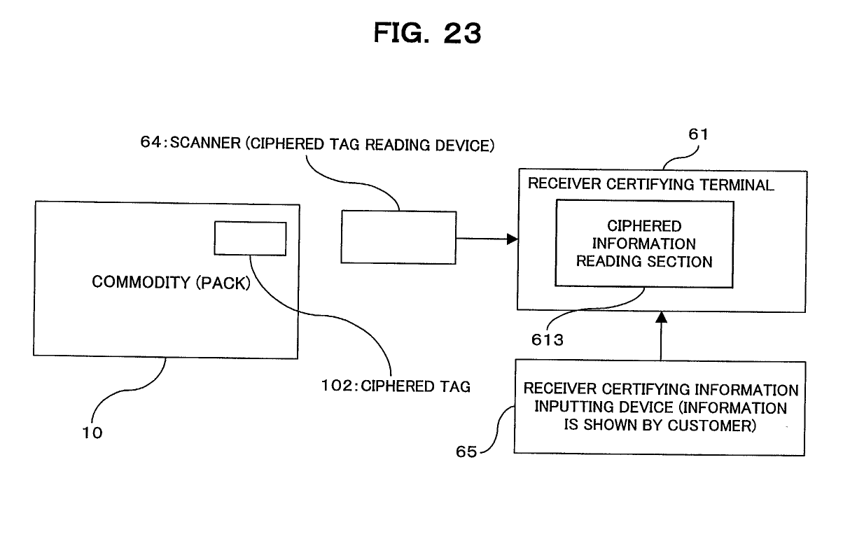

In the above-mentioned first modification, partly since any person having a bar-code reader can read information on the bar-code tag 101 which is attached to the commodity 10, partly since the “transaction number” and the “receiver certifying information” are stolen with ease, there is a security problem. As a solution, in the second modification, the shop 2 ciphers the “transaction number” with the “receiver certifying information” as a code key, and the ciphered “transaction number” in the form of a bar-code (ciphered) tag (slip medium) 102, as shown in FIG. 23, is attached to the package of the commodity 10. Then the commodity is delivered via the transportation system.

In this case, the receiver certifying terminal 61 having a ciphered information deciphering section 613 is installed at the commodity transfer place 6. Upon certification of the receiver for the commodity, the ciphered tag 102 is read by a scanner (ciphered tag reading device) 64 and is input to the receiver certifying terminal 61. After that, the “receiver certifying information” shown by the customer 3 is input to the receiver certifying terminal 61 by a receiver-certifying-information inputting device 65. The receiver-certifying information inputting device 65 may be a keyboard installed in the receiver certifying terminal 61, or, if the customer 3 restores the “transaction number” in the form of bar-code information, may be a scanner.

In a ciphered information deciphering section 613 of the receiver certifying terminal 61, the bar-code information read by the scanner 64 is deciphered with the “receiver certifying information” (code key) input from the receiver-certifying-information inputting device 65.

The deciphered “transaction number” is displayed on a non-illustrated screen of the receiver certifying terminal 61. When it is confirmed that the deciphered “transaction number” is identical with a “transaction number” attached to the package of the commodity or the like, the “receiver certifying information” input from the receiver-certifying-information input device 65 is valid and it is judged that the customer 3, who shows the valid “receiver certifying information”, is an authorized receiver for the commodity. Then the commodity is transferred to the customer 3.

Namely, in the illustrated modification, the ciphered tag (slip medium) 102 containing the “transaction number” ciphered with the “receiver certifying information” as a code key (read-out code) is attached to the commodity 10 and the commodity 10 is delivered to the commodity transfer place 6. Upon transfer of the commodity, the “transaction number” on the ciphered tag 102 is deciphered with the code key. If a correct deciphering is carried out, it is judged that the person who showed the “receiver certifying information” is an authorized receiver for the commodity 10.

In the illustrated modification, along with the same advantageous result as the first modification, since the receiver certification is not made by simply reading the “transaction number” from the ciphered tag 102, the commodity would not be transferred to a third person other than an authorized receiver even if the third person falsely reads the “transaction number” from the ciphered tag 102. Further, since only the “transaction number” which is ciphered with the “receiver certifying information” as a code key is recorded on the ciphered tag 102, it is possible to reduce the amount of information recorded on the ciphered tag 102. Meanwhile, the customer 3 inputs only the “receiver certifying information” to receive the commodity.

In alternative, the verification of the “receiver certifying information” may be carried out at the shop 2 (the shop's terminal 21) online. As a result, it is possible to realize the entire e-commerce system low in cost because the receiver certifying terminal 61 requires reduced functions, likewise the first modification.

(F-3) Third Modification

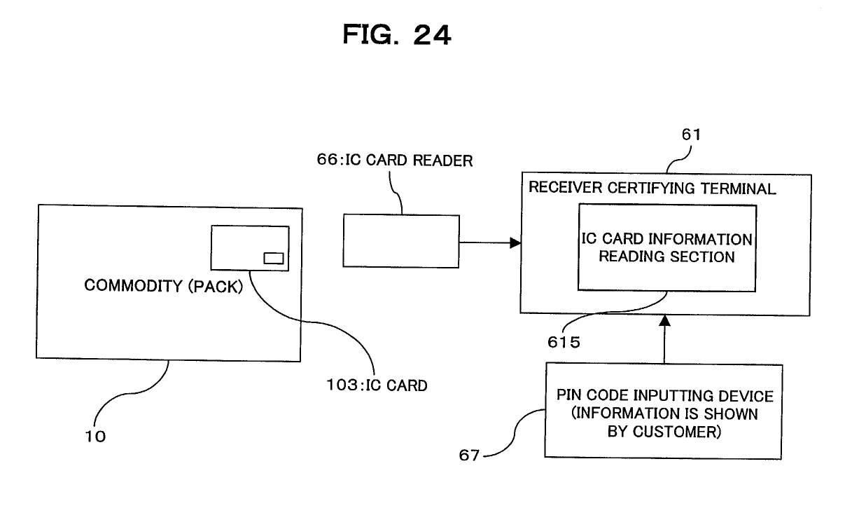

In a third modification, the certification of the receiver is performed by use of an electronic medium, such as an IC (Integrated Circuit) card, as a slip medium with reference to FIG. 24.

First of all, the shop 2 record the “transaction number” onto an IC card 103 whose PIN (Personal Identification Number) code (read-out code) for an access is the “receiver certifying information”, and attaches the IC card 103 to the package or other part of the commodity 10. At that time, the “transaction number” is also displayed on the package of the commodity 10. Then the commodity 10 with the IC card 103 to the commodity transfer place 6.

In this case, the receiver certifying terminal 61 having an IC card information reading section 615 is installed at the commodity transfer place 6. Upon certification of the receiver for the commodity, the IC card 103 is drawn from the package and is inserted in an IC card reader (a slip medium reading device) 66. At that time, the “receiver certifying information”, as a PIN code of the IC card 103, shown by the customer 3 is input to the receiver certifying terminal 61 via a PIN code inputting device 67. The IC card 103 has a function of certifying match/mismatch of PIN code.

Then the IC card information reading section 615 makes an access to the IC card using the input PIN code. When the input IC card is valid, the “transaction number” recoded onto the IC card 103 is read rightly. When the “transaction number” recoded onto the IC card 103 is confirmed to be identical with the “transaction number” attached to the package of the commodity 10, it is judged that the person who shows the “receiver certifying information” is an authorized receiver for the commodity 10 and the commodity 10 is transferred.

In the illustrated modification, along with the same advantageous result as the first modification, partly since it is hard to falsify the information on the IC card 103, partly since the IC card 103 is used as a slip medium, it is possible to surely prevent the commodity from being transferred to a third person who is an unauthorized receiver so that more secure transfer of the commodity 10 can be carried out.

In use of the IC card 103, a digital signature maybe registered in the IC card 103, and the “receiver certifying information” may be used as a key for the digital signature.

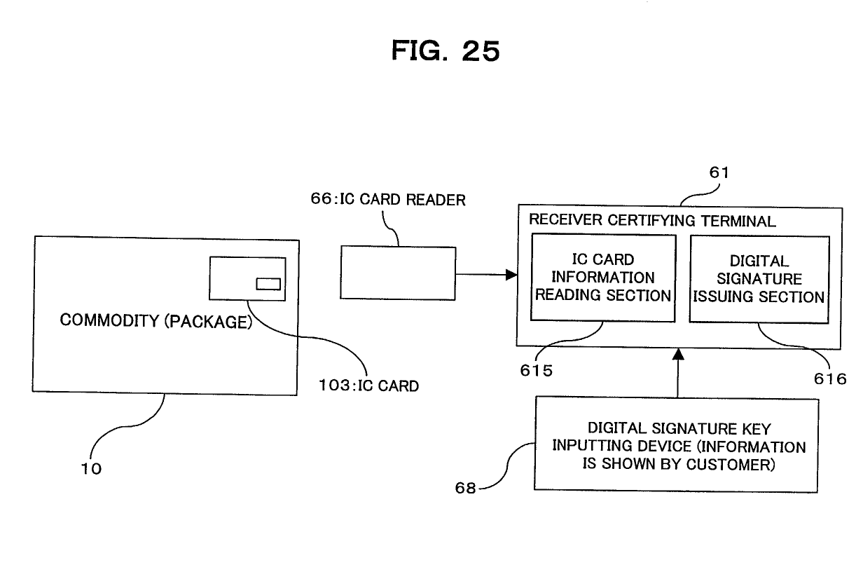

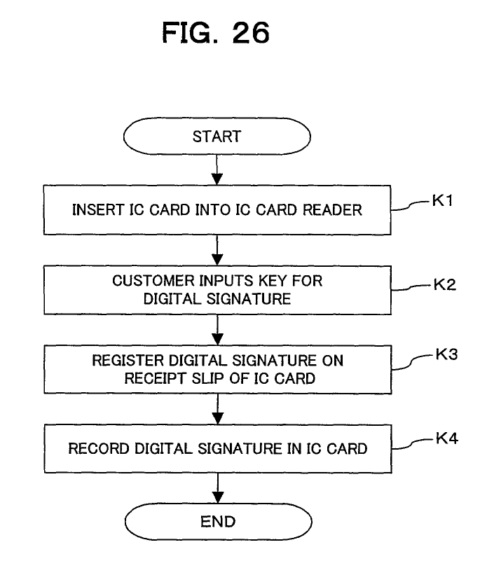

In this case, as shown in FIGS. 25, 26, the receiver certifying terminal 61 includes a digital signature issuing section 616. The IC card 103 is inserted into the IC card reader 66 (Step K1), whereupon the “receiver certifying information” is input from a digital signature key inputting device 68 (Step K2). The digital signature key inputting device 68 may be a keyboard installed in the receiver certifying terminal 61, or, if the customer 3 restores the “receiver certifying information” in the form of bar-code information, may be a scanner.

Subsequently, the IC card information reading section 615 reads the “transaction number” from the IC card 103 by use of the input “receiver certifying information” as the PIN code and the above-mentioned confirmation of an authorized receiver is performed. At that time, the “receiver certifying information” is used as a key for the digital signature and a digital signature is registered in a “receipt slip data” recorded in the IC card 103 by the digital signature issuing section 616 (Step K3) so that the “digital signature” is recorded (restored) in the IC card 103 (Step K4). It is thereby possible to record the transfer of the commodity to an authorized receiver in the IC card 103.

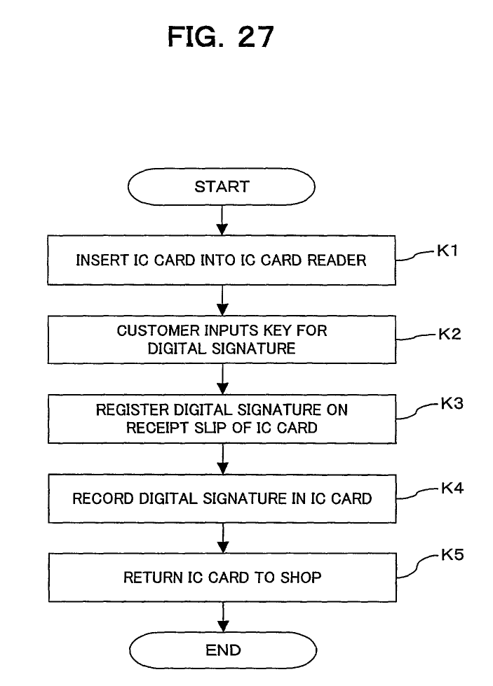

When the IC card 103 with the digital signature is delivered/returned to the shop 2 via the transportation system as a physical receipt slip (Step K5 in FIG. 27), it is possible for the shop 2 to surely confirm the completion of transfer of the commodity and to reuse the IC card for attaching to a commodity having another “transaction number” by overwriting information recorded in the returned IC card 103. Therefore, it is possible to make good use of resource for IC cards.

In alternative, the “digital signature” may be sent to the shop 2 (the shop's terminal 21) from the receiver certifying terminal 61 online. As a result, it is possible for the shop 2 to grasp the status of transfer of the commodity without time delay.

In another alternative, the “transaction number” recorded in the IC card 103 may be ciphered with the “receiver certifying information” as a code key. Namely, the “receiver certifying information” may be served as both a PIN code and a code key. Also in this case, since the confirmation cannot succeed only by reading information in the IC card 103, it is possible to surely prevent the commodity from being transferred to a third person is an unauthorized receiver even if the third person falsely reads the “transaction number” from the IC card 103.

(F-4) Fourth Modification

In the above-mentioned third modification, the IC card 103 is used as an electronic medium. In alternation, a “token”-type electronic medium having identical in function with the IC card 103 may also be used.

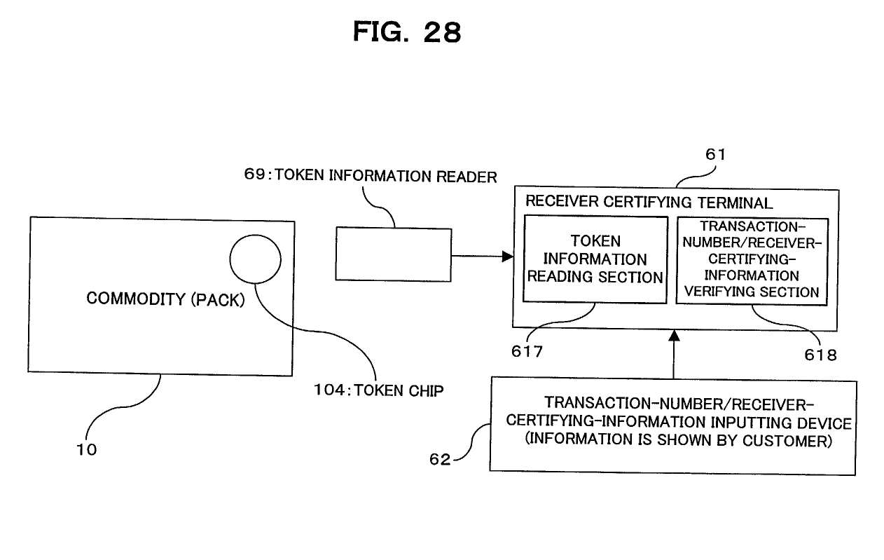

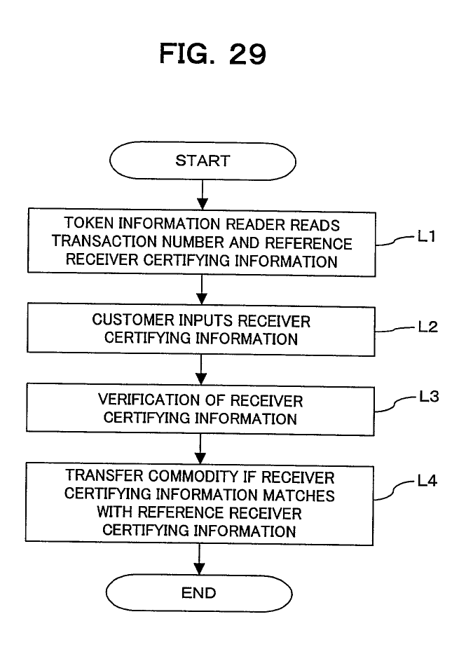

In this case, a token chip 104 containing the “transaction number” and the “receiver certifying information” as token information is attached to the package of the commodity 10, as shown in FIG. 28. The commodity 10 with the token chip 104 is delivered to the commodity transfer place 6. The receiver certifying terminal 61 functioning as a receiver certifying terminal and having a token information reading section 617 and a transaction-number/receiver-certifying-information verifying section 618 is installed at the commodity transfer place 6.

Upon transfer of the commodity, information on the token chip 104 is read by a token information reader (a slip medium reading device) 69, which is installed in the receiver certifying terminal 61, under the control of the token information reading section 617 (StepL1). And the transaction number” and the “receiver certifying information” shown by the customer 3 are input to the receiver certifying terminal 61 via a transaction-number/receiver-certifying-information inputting device 62 (Step L2).

Then the token information (the “transaction number” and the “receiver certifying information”) read from the token chip 104 is compared to the “transaction number” and the “receiver certifying information” shown by the customer (receiver) 3 for verification (Step L3). When the both sets of the “transaction number” and the “receiver certifying information” are identical, it is judged that the customer 3 is an authorized receiver for the commodity and the commodity is transferred to the customer 3 (Step L4).

Also in the illustrated modification, along with the same advantageous result as the first modification, it is possible to prevent the commodity from being transferred to an unauthorized third person due to difficulty in falsification of the “transaction number” and the “receiver certifying information”, likewise the use of the IC card 103.

Further, the “transaction number” can be ciphered with “receiver certifying information” as a code key, and the ciphered “transaction number” can be recorded in the token chip 104. As a result, it is possible to reduce the storage capacity necessitated for the token chip 104 and to reduce the amount of necessary information input by a receiver. The confirmation of “receiver certifying information” is also carried out at the shop 2 (the shop's terminal 21), and thereby generates the same advantageous result as the above-mentioned first through third modifications.

(F-5) Fifth Modification

In a fifth modification, biometrics data (e.g., such as fingerprint, palm print, finger shape, palm shape, voiceprint, iris code, blood vessel pattern, handwriting pressure, or keystroke) is used as the “receiver certification information”.

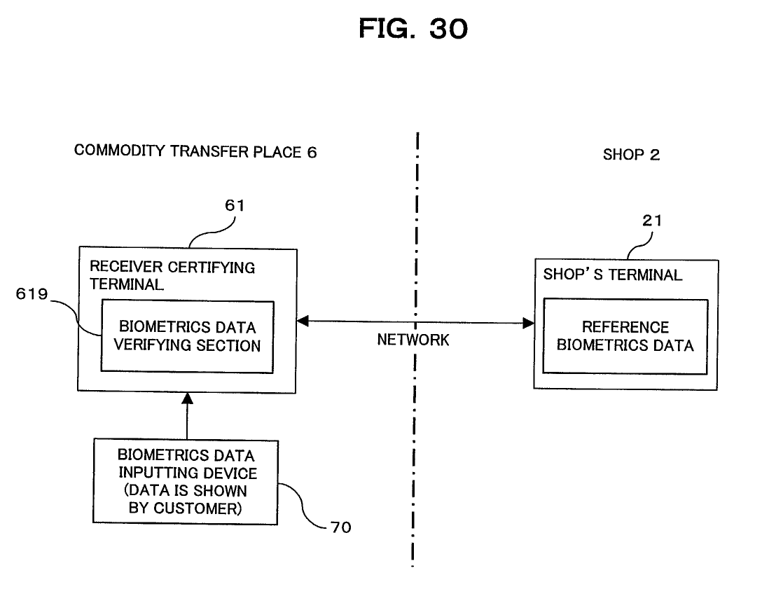

In this case, the receiver certifying terminal 61 disposed at the commodity transfer place 6 includes a biometrics data verifying section 619, as shown in FIG. 30. Upon transferring the commodity, biometrics data of a receiver is input to the receiver certifying terminal 61 from a biometrics data inputting device 70.

The biometrics data input from the biometrics data inputting device 70 is compared to reference biometrics data accumulated in the shop 2 by the biometrics data verifying section 619 for verification. The reference biometrics data may be previously provided by the shop 2 online, or may be provided by the shop 2 upon certification of the receiver.

When the biometrics data from the receiver is matched with the reference biometrics data, it is judged that the receiver is an authorized receiver for the commodity 10 and the commodity 10 is transferred to the receiver. Since the extremely exact certification of the receiver can be realized by use of the biometrics data upon certification of the receiver, it is possible to transfer the commodity 10 to the authorized receiver in further security.

The verification of the biometrics data may be carried out at the shop 2. As a result, it is possible to realize the entire e-commerce system reduced in cost, because the cost for the receiver certifying terminal 61 is reduced due to absence of some functions thereof. Particularly, since an apparatus having a function of verifying biometrics data is very expensive in general, it is more reasonable in cost to dispose the apparatus in the shop 2 to perform a centralized verification than to dispose the apparatus in the individual commodity transfer place 6.

Further, upon communication between the receiver certifying section 61 and the shop 2 (the shop's terminal 21), it is also possible to prevent personal biometrics data from leaking to a third person by use of the encryption technique, such as SSL.

(F-6) Sixth Modification

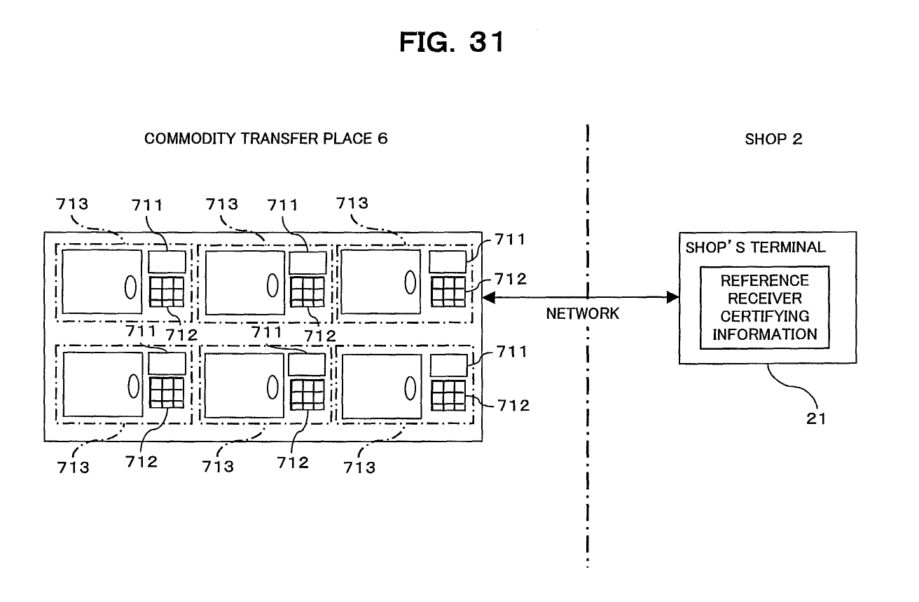

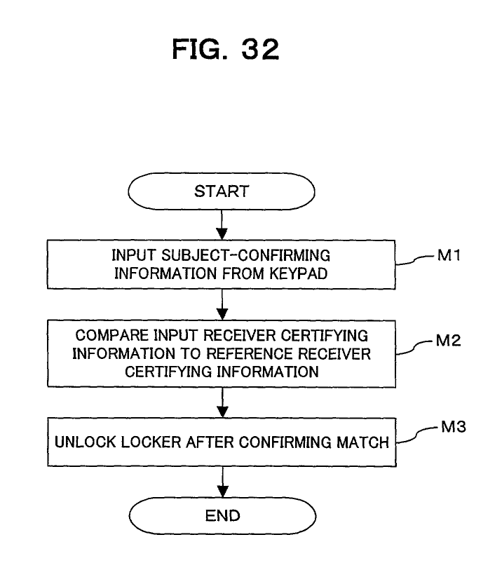

In the first through fifth modifications, a person other than a receiver is disposed upon transfer of the commodity. On the other hand, it is considered that a person other than the receiver does not disposed upon transfer of the commodity. For example, appropriate numbers of electronic locker (lockable commodity cabinets) 713 which are dedicated to each “transaction number” and whose PIN codes (unlock passwords) are the “receiver certifying information” are located at the commodity transfer place 6, as shown in FIG. 31.

The transportation company 5 delivers (deposits) the commodity to an electronic locker 713 whose transaction number displaying window 711 displays a “transaction number” identical with the “transaction number” displayed on the package of the commodity or the like, and then locks the electronic locker 713. The “transaction number” and the PIN code allocated to each electronic locker 713 are set by sending the electronic locker 713 the “transaction number” and the PIN code from the shop's terminal 21 online and then memorizing these information in the electronic locker 713.

The customer 3 of the commodity inputs the “receiver certifying information” from a keypad 712 corresponding to the transaction number displaying window 711 indicating the “transaction number” of the commodity which the customer 3 is going to receive (Step M1). In response, the electronic locker 713 compares the input “receiver certifying information” with the set (memorized) “receiver certifying information” (Step M2), and unlocks when the both “receiver certifying information” are identical (Step M3).

After the above-mentioned procedure, the customer 3 receives the commodity. Further, the completion of transferring the commodity may be automatically notified the shop 2 online.

In the illustrated modification, it is possible to realize correct certification of the receiver and correct transfer of the commodity without a person other than the receiver. As a result, since it is possible to surely transfer the commodity in secure even if there is no clerk at the commodity transfer place, the cost for hire can be reduced due to absence of a clerk, who performs certification of receiver, at the commodity transfer place 6.

The electronic locker 713 may further comprise a payment acceptance window in addition to the transaction number displaying window 711 and the keypad 712. With such payment acceptance window, the customer 3 may arranges the payment for the commodity via the payment acceptance window after the inputting of the “receiver certifying information” from the keypad 712 and then the electronic locker 713 may unlock. Namely, the customer 3 receive the commodity in return for paying a price of the purchasing of the commodity on the spot.

Accordingly, it is possible to realize secure transfer of the commodity and secure payment for the transaction between the customer 3 and the shop 2 even if the payment agent 4 or the purchase agent 7 does not exist therebetween. Especially, the illustrated modification is effectively applied to the above-mentioned fifth embodiment.

(G) Others

Further, the customer 3 may send an order for the commodity by an anonymous mail or an anonymous telephone. Namely, the above-mentioned e-commerce methods can also be applied to so-called mail order system. It is not always necessary the certification of the receiver using the “receiver certifying information” at the commodity transfer place 6. In alternative, the certification may not be always necessitated if only an authorized receiver for a commodity is allowed to enter the commodity transfer place 6.

The above-mentioned manners of commodity deliver and receiver certification should by no means be used only in the e-commerce system 1, 1A, 1B, 1C, 1D of the first through fifth embodiments. In alternative, the manners may be performed independently. Further, throughout the embodiments, the information terminal (the commodity transfer place's terminal) 61, which is located in the commodity transfer place 6 and which has a function of communicating information, also functions as a receiver certifying terminal. In alternative, the information terminal 61 and the receiver certifying terminal may, of course, located in the form of two dedicated terminals.

Further, the present invention should by no means be limited to these foregoing embodiments, and various changes or other modifications may be suggested without departing from the gist of the invention.

What is claimed is:

1. An e-commerce method for an e-commerce system, which includes a seller's terminal, a customer's terminal, a payment agent's terminal for making payment in behalf of the customer's terminal when a customer purchases a commodity from a seller, and commodity delivery means for delivering the commodity to a designated delivery destination, each of these various elements of the system having a function of communicating information with a desired information communication network, said method comprising the steps of:
at the customer's terminal
(a) sending an order to the seller's terminal for a commodity via the information communication network and designating a non-residential place other than a residential place of the customer as the delivery destination via the information communication network;
at the seller's terminal
(b) notifying the customer's terminal of transaction identification (ID) information peculiar to said order via the information communication network;
(c) requesting the payment agent's terminal for payment for the commodity, for which the customer's terminal made the order, using said transaction ID information;
(d) making arrangements to deliver the commodity to said non-residential place using the commodity delivery means; and
at the commodity delivery means
(e) transferring the commodity to a receiver for the commodity at said non-residential place.

2. An e-commerce method according to claim 1, wherein in said commodity transferring step (e), certification is made as to whether the receiver for the commodity is an authorized receiver, using receiver certifying information, which has been previously communicated between the seller and the customer.

3. An e-commerce method according to claim 2, wherein:
in said transaction ID information notifying step (b), said receiver certifying information, which is created at the seller's terminal, and price information of the transaction, together with said transaction ID information, are notified to the customer's terminal; and
in said payment requesting step (c), the customer's terminal notifies the payment agent's terminal of said transaction ID information and said price information, which have been notified by said seller's terminal, via the information communication network as the payment request.

4. An electronic transaction method according to claim 2, wherein in said order sending step (a), the customer's terminal notifies the seller's terminal of receiver certifying information, which has been created by the customer's terminal when the customer's terminal has made said order, via the information communication network.

5. An e-commerce method according to claim 2, wherein:
in said commodity delivering step (d), a sales slip medium containing said transaction ID information in the form of a read-out code representing said receiver certifying information is delivered to said non-residential place and is attached to the commodity; and
in said commodity transferring step (e), the receiver for the commodity is certified as the authorized receiver, by reading out said transaction ID information of said sales slip medium using said receiver certifying information, which is known to the customer's terminal, as said read-out code.

6. An e-commerce method according to claim 5, wherein:
in said commodity delivering step (d), said transaction ID information is ciphered with said read-out code as a code key; and
in said commodity transferring step (e), said ciphered transaction ID information of said sales slip medium is deciphered using said code key.

7. An e-commerce method according to clam 5, wherein a digital signature of the authorized receiver for the commodity is recorded in said sale slip medium using said receiver certifying information as a key for said digital signature of said sales slip medium.

8. An e-commerce method according to claim 7, wherein said sales slip medium in which said digital signature is recorded is delivered to the seller's terminal as a reusable receipt slip by the commodity delivery means.

9. An e-commerce method according to claim 2, wherein:
in said commodity delivering step (d), the commodity is delivered to a lockable commodity cabinet which is located in said non-residential place and is unlocked when said receiver certifying information, which is known to the customer's terminal, is input with respect to said commodity cabinet; and
in said commodity transferring step (e), said transferring of the commodity is carried out as said commodity cabinet is unlocked by inputting said receiver certifying information, which is known to the customer's terminal, with respect to said commodity cabinet.

10. An e-commerce method according to claim 2 wherein said receiver certifying information is biometrics data.

11. An e-commerce method according to claim 1, wherein upon completion of delivery of the commodity to said non-residential place by said commodity delivering step (d) , the seller's terminal notifies the customer's terminal of the completion of delivery of the commodity via the information communication network.

12. An e-commerce method according to claim 11, wherein in said commodity transferring step (e), certification is made as to whether the receiver for the commodity is an authorized receiver, using receiver certification information, which has been previously communicated between the seller and the customer.

13. An e-commerce method according to claim 1, further comprising a step of notifying the customer's terminal of a status of delivery of the commodity in said commodity delivering step (d) by making a notice on information bulletin board means set up in the information communication network and notified by the customer's terminal.

14. An e-commerce method according to claim 1, wherein:
at the customer's terminal
the customer makes arrangements to pay a predetermined amount of money periodically to a customer's account established for the payment agent to make payment in behalf of the customer; and
at the payment agent's terminal
the payment agent makes a direct debit of a price regarding the purchasing of the commodity in said customer's account to make the payment.

15. An e-commerce method according to claim 1, wherein at the commodity delivery means, it is notified to the seller's terminal via the information communication network that said transferring of the commodity has been carried out in said commodity transferring step (e).

16. An e-commerce method according to claim 1, wherein in said order sending step (a), information about the customer also is sent from the customer's terminal to the seller's terminal via the information communication network as marketing information.

17. An e-commerce method according to claim 1, wherein upon receipt of said marketing information from the customer's terminal, at the seller's terminal the seller makes a discount of the price of the commodity.

18. An e-commerce method according to claim 16, wherein said marketing information is age/sex information of the customer.

19. An e-commerce method for an e-commerce system which includes a seller's terminal, a customer's terminal, a purchase agent's terminal for making arrangements to purchase a commodity in behalf of the customer's terminal, and commodity delivery means for delivering the commodity to a designated delivery destination, each of these various elements of the system having a function of communicating information with a desired information communication network, said method comprising the steps of:
at the customer's terminal
(a) requesting the purchase agent's terminal to make arrangements to purchase a commodity via the information communication network and designating a non-residential place other than a residential place of the customer as the delivery destination via the information communication network;
at the purchase agent's terminal
(b) sending, upon receipt of the commodity purchase request, an order to the seller's terminal for the commodity and designating said non-residential place as the delivery destination, via the information communication network;
at the seller's terminal
(c) notifying the purchase agent's terminal of price information peculiar to said order via the information communication network;
at the purchase agent's terminal
(d) making the payment of the price to the seller's terminal in accordance with said price information using information peculiar to said order as transaction identification (ID) information;
at the seller's terminal
(e) making arrangements to deliver the commodity to said non-residential place using the commodity delivery means; and
at the commodity delivery means
(f) transferring the commodity to a receiver for the commodity at said non-residential place.

20. An e-commerce method according to claim 19, wherein upon completion of delivery of the commodity to said non-residential place by said commodity delivering step (e), the purchase agent's terminal notifies the customer's terminal of the completion of delivery of the commodity via the information communication network.

21. An e-commerce method according to claim 19, further comprising a step of notifying the customer's terminal of a status of delivery of the commodity in said commodity delivering step (e) by making a notice on information bulletin board means set up in the information communication network and notified by the customer's terminal.

22. An e-commerce method according to claim 21, wherein:
at the customer's terminal
the customer makes arrangements to pay a predetermined amount of money periodically to a customer's account established for the payment agent to make payment in behalf of the customer; and
at the payment agent's terminal
the payment agent makes a direct debit of a price regarding the purchasing of the commodity in said customer's account to make the payment.

23. An e-commerce method according to claim 19, wherein in said commodity transferring step (f), certification is made as to whether the receiver for the commodity is an authorized receiver, using receiver certification information, which has been previously communicated between the seller and the customer.

24. An e-commerce method according to claim 23, wherein:
in said commodity delivering step (e), a sales slip medium containing said transaction ID information in the form of a read-out code representing said receiver certifying information is delivered to said non-residential place and is attached to the commodity; and
in said commodity transferring step (f), the receiver for the commodity is certified as the authorized receiver, by reading out said transaction ID information of said sales slip medium using said receiver certifying information, which is known to the customer's terminal, as said read-out code.

25. An e-commerce method according to claim 24, wherein:
in said commodity delivering step (e), said transaction ID information is ciphered with said read-out code as a code key; and
in said commodity transferring step (f), said ciphered transaction ID information of said sales slip medium is deciphered using said code key.

26. An e-commerce method according to clam 24, wherein a digital signature of the authorized receiver for the commodity is recorded in said sale slip medium using said receiver certifying information as a key for said digital signature of said sales slip medium.

27. An e-commerce method according to claim 26, wherein said sales slip medium in which said digital signature is recorded is delivered to the seller's terminal as a reusable receipt slip by the commodity delivery means.

28. An e-commerce method according to claim 23, wherein:
in said commodity delivering step (e), the commodity is delivered to a lockable commodity cabinet which is located in said non-residential place and is unlocked when said receiver certifying information, which is known to the customer's terminal, is input with respect to said commodity cabinet; and
in said commodity transferring step (f), said transferring of the commodity is carried out as said commodity cabinet is unlocked by inputting said receiver certifying information, which is known to the customer's terminal, with respect to said commodity cabinet.

29. An e-commerce method according to claim 23, wherein said receiver certifying information is biometrics data.

30. An e-commerce method according to claim 19, wherein:
at the customer's terminal
the customer makes arrangements to pay a predetermined amount of money periodically to a customer's account established for the purchase agent to make payment in behalf of the customer; and
at the purchase agent's terminal
the purchase agent makes a direct debit of a price regarding the purchasing of the commodity in said customer's account to make the payment.

31. An e-commerce method according to claim 19, wherein at the commodity delivery means, it is notified to the seller's terminal via the information communication network that said transferring of the commodity has been carried out in said commodity transferring step (f).

32. An e-commerce method for an e-commerce system, which includes a seller's terminal, a customer's terminal, a purchase agent's terminal for making arrangements to purchase a commodity in behalf of the customer's terminal, a settlement agent's terminal for making arrangements to settle for the purchase of the commodity in behalf of the customer, and commodity delivery means for delivering the commodity to a designated delivery destination, each of these various elements of the system having a function of communicating information with a desired information communication network, said method comprising the steps of:
at the customer's terminal
(a) requesting the purchase agent's terminal to make arrangements to purchase a commodity via the information communication network and designating a non-residential place other than a residential place of the customer as the delivery destination via the information communication network;
at the purchase agent's terminal
(b) sending, upon receipt of the commodity purchase request, an order to the seller's terminal for the commodity and designating said non-residential place as the delivery destination, via the information communication network;
at the seller's terminal
(c) notifying the purchase agent's terminal of price information peculiar to said order via the information communication network;
at the purchase agent's terminal
(d) making arrangements to pay the price to the seller's terminal in accordance with said price information using information peculiar to said order as transaction identification (ID) information;
(e) requesting the settlement agent's terminal for the payment in accordance with the price information corresponding to the settlement arrangements which the purchase agent's terminal has made in behalf of the customer's terminal, via the information communication network;
at the settlement agent's terminal
(f) making arrangements to pay to the purchase agent's terminal the price corresponding to the payment request upon receipt of the payment request from the purchase agent's terminal;
at the seller's terminal
(g) making arrangements to deliver the commodity to said non-residential place using the commodity delivery means; and
at the commodity delivery means
(h) transferring the commodity to a receiver at said non-residential place.

33. An e-commerce method according to claim 32, wherein upon completion of delivery of the commodity to said non-residential place by said commodity delivering step (g), the purchase agent's terminal notifies the customer's terminal of the completion of delivery of the commodity via the information communication network.

34. An e-commerce method according to claim 32, further comprising a step of notifying the customer's terminal of a status of delivery of the commodity in said commodity delivering step (g) by making a notice on information bulletin board means set up in the information communication network and notified by the customer's terminal.

35. An e-commerce method according to claim 34, wherein:
at the customer's terminal
the customer makes arrangements to pay a predetermined amount of money periodically to a customer's account established for the payment agent to make payment in behalf of the customer; and
at the payment agent's terminal
the payment agent makes a direct debit of a price regarding the purchasing of the commodity in said customer's account to make the payment.

36. An e-commerce method according to claim 32, wherein in said commodity transferring step (h), certification is made as to whether the receiver for the commodity is an authorized receiver, using receiver certification information which has been previously communicated between the seller and the customer.

37. An e-commerce method according to claim 36, wherein:
in said commodity delivering step (g), a sales slip medium containing said transaction ID information in the form of a read-out code representing said receiver certifying information is delivered to said non-residential place and is attached to the commodity; and
in said commodity transferring step (h), the receiver for the commodity is certified as the authorized receiver, by reading out said transaction ID information of said sales slip medium using said receiver certifying information, which is known to the customer's terminal, as said read-out code.

38. An e-commerce method according to claim 37, wherein:
in said commodity delivering step (g), said transaction ID information is ciphered with said read-out code as a code key; and
in said commodity transferring step (h), said ciphered transaction ID information of said sales slip medium is deciphered using said code key.

39. An e-commerce method according to clam 37, wherein a digital signature of the authorized receiver for the commodity is recorded in said sale slip medium using said receiver certifying information as a key for said digital signature of said sales slip medium.

40. An e-commerce method according to claim 39, wherein said sales slip medium in which said digital signature is recorded is delivered to the seller's terminal as a reusable receipt slip by the commodity delivery means.

41. An e-commerce method according to claim 36, wherein:
in said commodity delivering step (g), the commodity is delivered to a lockable commodity cabinet which is located in said non-residential place and is unlocked when said receiver certifying information, which is known to the customer's terminal, is input with respect to said commodity cabinet; and
in said commodity transferring step (h), said transferring of the commodity is carried out as said commodity cabinet is unlocked by inputting said receiver certifying information, which is known to the customer's terminal, with respect to said commodity cabinet.

42. An e-commerce method according to claim 36, wherein said receiver certifying information is biometrics data.

43. An e-commerce method according to claim 32, wherein:
at the customer's terminal
the customer makes arrangements to pay a predetermined amount of money periodically to a customer's account established for the purchase agent to make payment in behalf of the customer; and
at the purchase agent's terminal
the purchase agent makes a direct debit of a price regarding the purchasing of the commodity in said customer's account to make the payment.

44. An e-commerce method according to claim 32, wherein at the commodity delivery means, it is notified to the seller's terminal via the information communication network that said transferring of the commodity has been carried out in said commodity transferring step (h).

45. An e-commerce method for an e-commerce system, which includes a seller's terminal, a customer's terminal, a payment agent's terminal for making arrangements to pay the price of a commodity in behalf of the customer's terminal, and commodity delivery means for delivering the commodity to a designated destination, each of these various elements of the system having a function of communicating information with a desired information communication network, said method comprising the steps of:
at the customer's terminal
(a) requesting the payment agent's terminal to make arrangements to deliver a commodity to a delivery destination via the information communication network and designating a non-residential place other than a residential place of the customer as the delivery destination via the information communication network;
at the payment agent's terminal
(b) warranting the payment relating to purchase between the seller's terminal and the customer's terminal, which purchase is to be identified by transaction identification (ID) information peculiar to the delivery request, by an electronic document;
at the commodity delivery means
(c) making arrangements to deliver the commodity to said non-residential place after said payment is warranted by said electronic document; and
at the commodity delivery means
(d) transferring the commodity to a receiver at said non-residential place.

46. An e-commerce method according to claim 45, wherein in said commodity transferring step (d), certification is made as to whether the receiver for the commodity is an authorized receiver, using receiver certification information, which has been previously communicated between the payment agent and the customer.

47. An e-commerce method according to claim 46, wherein:
in said commodity delivering step (c), a sales slip medium containing said transaction ID information in the form of a read-out code representing said receiver certifying information is delivered to said non-residential place and is attached to the commodity; and
in said commodity transferring step (d), the receiver for the commodity is certified as the authorized receiver, by reading out said transaction ID information of said sales slip medium using said receiver certifying information, which is known to the customer's terminal, as said read-out code.

48. An e-commerce method according to claim 47, wherein:
in said commodity delivering step (c), said transaction ID information is ciphered with said read-out code as a code key; and
in said commodity transferring step (d), said ciphered transaction ID information of said sales slip medium is deciphered using said code key.

49. An e-commerce method according to clam 47, wherein a digital signature of the authorized receiver for the commodity is recorded in said sale slip medium using said receiver certifying information as a key for said digital signature of said sales slip medium.

50. An e-commerce method according to claim 49, wherein said sales slip medium in which said digital signature is recorded is delivered to the seller's terminal as a reusable receipt slip by the commodity delivery means.

51. An e-commerce method according to claim 46, wherein:
in said commodity delivering step (c), the commodity is delivered to a lockable commodity cabinet which is located in said non-residential place and is unlocked when said receiver certifying information, which is known to the customer's terminal, is input with respect to said commodity cabinet; and
in said commodity transferring step (d), said transferring of the commodity is carried out as said commodity cabinet is unlocked by inputting said receiver certifying information, which is known to the customer's terminal, with respect to said commodity cabinet.

52. An e-commerce method according to claim 46, wherein said receiver certifying information is biometrics data.

53. An e-commerce method according to claim 46, wherein at the commodity delivery means, it is notified to the seller's terminal via the information communication network that said transferring of the commodity has been carried out in said commodity transferring step (d).

54. An e-commerce method according to claim 45, further comprising the step of:
at the payment agent's terminal
making arrangements to pay to the seller's terminal via the information communication network for the price relating to the purchase in behalf of the customer's terminal when said transferring of the commodity is confirmed by the payment agent's terminal.

55. An e-commerce method according to claim 45, wherein at the commodity delivery means, it is notified to the payment agent's terminal via the information communication network that said transferring of the commodity has been carried out in said commodity transferring step (d).

56. An e-commerce method for an e-commerce system, which includes a seller's terminal, a customer's terminal, and commodity delivery means for delivering the commodity to a designated destination, each of these various elements of the system having a function of communicating information with a desired information communication network, said method comprising the steps of:
at the customer's terminal
(a) sending an order to the seller's terminal for purchase of a commodity via the information communication network and designating a non-residential place other than a residential place of the customer as the delivery destination via the information communication network;
at the seller's terminal
(b) notifying transaction identification (ID) information, which is peculiar to said order, to the customer's terminal via the information communication network;
(c) making arrangements to deliver the commodity to said non-residential place; and
at the commodity delivery means
(d) receiving the payment by a receiver for the purchase relating to said order using said transaction ID information at said non-residential place and transferring the commodity to said receiver at said non-residential place upon receipt of the payment.

57. An e-commerce method according to claim 56, wherein in said commodity transferring step (d), certification is made as to whether the receiver for the commodity is an authorized receiver, using receiver certifying information, which has been previously communicated between the seller and the customer.

58. An e-commerce method according to claim 57, wherein:
in said commodity delivering step (c), a sales slip medium containing said transaction ID information in the form of a read-out code representing said receiver certifying information is delivered to said non-residential place and is attached to the commodity; and
in said commodity transferring step (d), the receiver for the commodity is certified as the authorized receiver, by reading out said transaction ID information of said sales slip medium using said receiver certifying information, which is known to the customer's terminal, as said read-out code.

59. An e-commerce method according to claim 58, wherein:
in said commodity delivering step (c), said transaction ID information is ciphered with said read-out code as a code key; and
in said commodity transferring step (d), said ciphered transaction ID information of said sales slip medium is deciphered using said code key.

60. An e-commerce method according to clam 58, wherein a digital signature of the authorized receiver for the commodity is recorded in said sale slip medium using said receiver certifying information as a key for said digital signature of said sales slip medium.

61. An e-commerce method according to claim 60, wherein said sales slip medium in which said digital signature is recorded is delivered to the seller's terminal as a reusable receipt slip by the commodity delivery means.

62. An e-commerce method according to claim 57, wherein:
in said commodity delivering step (c), the commodity is delivered to a lockable commodity cabinet which is located in said non-residential place and is unlocked when said receiver certifying information, which is known to the customer's terminal, is input with respect to said commodity cabinet; and
in said commodity transferring step (d), said transferring of the commodity is carried out as said commodity cabinet is unlocked by inputting said receiver certifying information, which is known to the customer's terminal, with respect to said commodity cabinet.

63. An e-commerce method according to claim 57, wherein said receiver certifying information is biometrics data.

64. An e-commerce method according to claim 56, wherein at the commodity delivery means, it is notified to the seller's terminal via the information communication network that said transferring of the commodity has been carried out in said commodity transferring step (d).
